(19) United States
(12) Patent Application Publication
(10) Pub. No.: US 2025/0368468 A1
(43) Pub. Date: Dec. 4, 2025

(54) MEDIUM PROCESSING APPARATUS AND IMAGE FORMING SYSTEM INCORPORATING SAME

(71) Applicant: Ricoh Company, Ltd., Ohta-ku, Tokyo (JP)

(72) Inventors: Kazuki SETO, Kanagawa (JP); Kei SASAKI, Kanagawa (JP); Kohta ABE, Kanagawa (JP); Hidehiko FUJIWARA, Kanagawa (JP); Takeshi AKAI, Kanagawa (JP); Riko YAGI, Kanagawa (JP)

(73) Assignee: Ricoh Company, Ltd., Ohta-ku, Tokyo (JP)

(21) Appl. No.: 18/860,896

(22) PCT Filed: May 19, 2023
(86) PCT No.: PCT/IB2023/055153

§ 371 Date: Oct. 28, 2024

(30) Foreign Application Priority Data
May 27, 2022 (JP) 2022-086931
Jun. 23, 2022 (JP) 2022-100950
Mar. 24, 2023 (JP) 2023-048397
Mar. 27, 2023 (JP) 2023-049890

(51) Int. Cl. B65H 37/04; B41J 3/44; B42C 19/00; G03G 15/00

(52) U.S. Cl. CPC B65H 37/04; B41J 3/44; B42C 19/00; G03G 15/6544; B65H 2301/51616; B65H 2301/5162; G03G 2215/00801

(57) ABSTRACT

A medium processing apparatus includes a liquid applier to apply liquid to a part of a medium and a post-processing device to perform processing on a bundle of media including the medium to which the liquid is applied by the liquid applier. The liquid applier includes a liquid storage to store the liquid, a liquid supply portion having one end immersed in the liquid stored in the liquid storage to absorb the liquid toward another end of the liquid supply portion, and a liquid application member coupled to the other end of the liquid supply portion and having a contact surface to contact the medium to apply the liquid supplied from the liquid supply portion to the medium. The contact surface of the liquid application member with the medium is at a position higher than a position of an uppermost surface of the liquid stored in the liquid storage.

### TECHNICAL FIELD

Embodiments of the present disclosure relate to a medium processing apparatus and an image forming system incorporating the medium processing apparatus.

### BACKGROUND ART

Medium processing apparatuses are known in the related art that bind, into a bundle, sheet-like media on which images are formed by image forming apparatuses. Since sheets of paper are widely known as an example of sheet-shaped media, a “sheet bundle” that is a stack of sheets of paper is used as an example of a bundle of sheet-shaped media in the following description. Some medium processing apparatuses include a crimper that can perform so-called “crimp binding” without metal binding needles from a viewpoint of resource saving and reduction in environmental load. Specifically, the crimper sandwiches a sheet bundle with serrate binding teeth to press and deform the sheet bundle.

An increased number of sheets of the sheet bundle hamper the binding teeth in biting into the sheet bundle and may cause some sheets to peel off from the bound sheets. Thus, the crimp binding has some difficulties in keeping the sheet bundle bound as appropriate. To increase the binding strength, some medium processing apparatuses that execute the crimp binding include a binding unit that applies liquid in advance to a position on a sheet where the binding teeth contact the sheet, to allow the binding teeth to easily bite into a sheet bundle (for example, see PTL 1).

### CITATION LIST

### Patent Literature

### [PTL 1]

Japanese Unexamined Patent Application Publication No. 2018-199245

### SUMMARY OF INVENTION

### Problem to be Solved

However, the binding unit described in PTL 1 moves in the width direction of the sheet with a pump for pumping up water stored in a water replenishing tank being mounted in the binding unit. As a result, a problem arises that the binding unit increases in size and complexity.

The present disclosure has been made in order to solve such a problem, and an object of the present disclosure is to provide a technology for downsizing and simplifying a liquid applier in a medium processing apparatus that applies liquid to a medium and then performs crimp binding.

### Solution to Problem

According to an aspect of the disclosure, a medium processing apparatus includes a liquid applier and a post-processing device. The liquid applier applies liquid to a part of a medium, the medium being at least one medium. The post-processing device performs processing on a bundle of media including the medium to which the liquid is applied by the liquid applier. The liquid applier includes a liquid storage, a liquid supply portion, and a liquid application member. The liquid storage stores the liquid to be applied by the liquid applier. The liquid supply portion has one end immersed in the liquid stored in the liquid storage to absorb the liquid toward another end of the liquid supply portion. The liquid application member is coupled to said another end of the liquid supply portion. The liquid application member has a contact surface to contact the medium to apply the liquid supplied from the liquid supply portion to the medium. The contact surface of the liquid application member with the medium is at a position higher than a position of an uppermost surface of the liquid stored in the liquid storage.

### Advantageous Effects of Invention

According to one or more embodiments of the present disclosure, a liquid applier can be reduced in size and simplified in a medium processing apparatus that performs crimp binding after liquid application to a medium.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a diagram illustrating an overall configuration of an image forming system according to an embodiment of the present disclosure.

FIG. 2 is a diagram illustrating an internal configuration of a post-processing apparatus according to a first embodiment of the present disclosure.

FIG. 3 is a schematic view of an upstream side of an edge binder of the post-processing apparatus of FIG. 2 in a conveyance direction.

FIG. 4 is a schematic view of a liquid applier of the edge binder of FIG. 3 in a main scanning direction.

FIGS. 5A and 5B are schematic diagrams illustrating a configuration of a crimper of the edge binder of FIG. 3.

FIG. 6 is a schematic view of an upstream side of a stapling unit of the post-processing apparatus of FIG. 2 in a conveyance direction.

FIG. 7 is a schematic view of an upstream side of a stapling unit as a modification of the stapling unit of FIG. 6 in the conveyance direction.

FIG. 8 is a block diagram illustrating a hardware configuration of the post-processing apparatus of FIG. 2 to control the post-processing apparatus.

FIG. 9 is a flowchart of a binding process performed by the edge binder of FIG. 3.

FIGS. 10A, 10B, and 10C are diagrams illustrating the positions of a liquid applier and a crimper during the binding process of FIG. 9.

FIGS. 11A, 11B, and 11C are diagrams illustrating an operation of a liquid applier as viewed from an upstream side in the conveyance direction.

FIGS. 12A, 12B, and 12C are diagrams illustrating the operation of the liquid applier as viewed from the side on which the liquid applier is disposed in a main scanning direction.

FIGS. 13A, 13B, and 13C are diagrams illustrating an operation of a liquid applier according to a first modification of an embodiment of the present disclosure, as viewed from the side on which the liquid applier is disposed in a main scanning direction.

FIGS. 14A and 14B are diagrams illustrating the arrangement and configuration of a second liquid storage in the post-processing apparatus of FIG. 2.

FIG. 15 is a diagram illustrating an attachment and detachment configuration of the second liquid storage of FIGS. 14A and 14B.

FIG. 16 is a flowchart of a liquid-amount control process according to an embodiment of the present disclosure.

FIGS. 17A, 17B, and 17C are diagrams illustrating a binding process performed by the edge binder of FIG. 3, according to a modification of an embodiment of the present disclosure;

FIG. 18A is a cross-sectional view of a liquid applier according to an embodiment of the present disclosure; FIG. 18B is a perspective view of the liquid applier of FIG. 18A; and FIG. 18C is a diagram illustrating a liquid application cover viewed from the side on which a protection cap is disposed.

FIG. 19A is a cross-sectional view of a liquid applier according to another embodiment of the present disclosure; FIG. 19B is a perspective view of the liquid applier of FIG. 19A; and FIG. 19C is a diagram illustrating a liquid application cover viewed from the side on which a protection cap is disposed.

FIGS. 20A, 20B, and 20C are diagrams illustrating a process of contacting a liquid application member against a sheet.

FIGS. 21A, 21B, and 21C are diagrams illustrating a process of contacting and separating the liquid application member with and from a protection cap.

FIG. 22 is a diagram illustrating the internal configuration of a post-processing apparatus according to a second embodiment of the present disclosure.

FIGS. 23A, 23B, and 23C are schematic views of an internal tray of the post-processing apparatus according to the second embodiment, viewed from a thickness direction of a sheet.

FIG. 24 is a schematic view of a crimper of the post-processing apparatus according to the second embodiment, viewed from an upstream side in a conveyance direction.

FIGS. 25A and 25B are schematic views of a liquid applier of the post-processing apparatus according to the second embodiment, viewed from the thickness direction of the sheet;

FIGS. 26A, 26B, and 26C are cross-sectional views of a liquid application unit of the liquid applier taken through XXV-XXV of FIG. 25A;

FIGS. 27A, 27B, and 27C are cross-sectional views of the liquid application unit of the liquid applier taken through XXVI-XXVI of FIG. 25A.

FIG. 28 is a block diagram illustrating the hardware configuration of controlling the operation of the post-processing apparatus according to the second embodiment.

FIG. 29 is a flowchart of post-processing performed by the post-processing apparatus according to the second embodiment.

FIG. 30 is a diagram illustrating the overall configuration of an image forming system according to a modification of the embodiment illustrated in FIG. 1.

### DESCRIPTION OF EMBODIMENTS

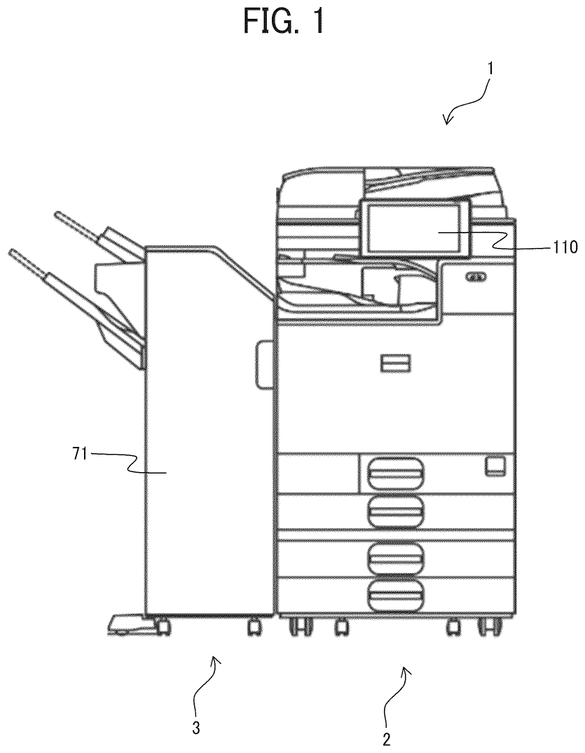

A description is given below of an image forming system 1 according to an embodiment of the present disclosure, with reference to the drawings. FIG. 1 is a diagram illustrating the overall configuration of the image forming system 1. The image forming system 1 has a function of forming an image on a sheet P as a sheet-shaped medium and performing post-processing on the sheet P on which the image is formed. As illustrated in FIG. 1, the image forming system 1 includes an image forming apparatus 2 and a post-processing apparatus 3 serving as a medium processing apparatus according to the embodiments of the present disclosure.

The image forming apparatus 2 forms an image on the sheet P and ejects the sheet having the image to the post-processing apparatus 3. The image forming apparatus 2 includes a tray that accommodates the sheet P, a conveyor that conveys the sheet P accommodated in the tray, and an image forming device that forms an image on the sheet P conveyed by the conveyor. The image former may be an inkjet image forming device that forms an image with ink or an electrophotographic image forming device that forms an image with toner. Since the image forming apparatus 2 has a typical configuration, a detailed description of the configuration and functions of the image forming apparatus 2 are omitted.

Now, a description is given of the post-processing apparatus 3 according to a first embodiment of the present disclosure.

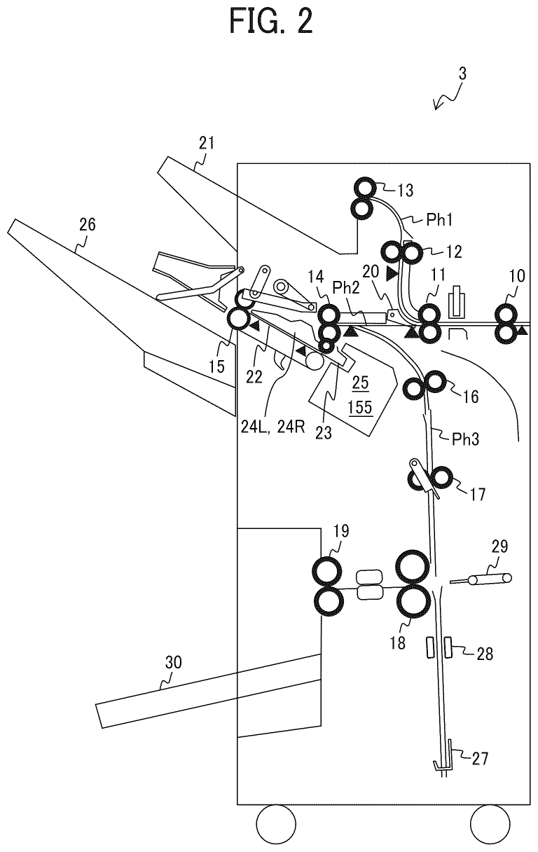

FIG. 2 is a diagram illustrating an internal configuration of the post-processing apparatus 3. The post-processing apparatus 3 performs post-processing on the sheet P on which an image is formed by the image forming apparatus 2. An example of the post-processing according to the present embodiment is binding or a binding process as a “crimp binding process” to bind, without staples, a plurality of sheets P on each of which an image is formed as a bundle of sheets P, which may be referred to as a sheet bundle. Another example of the post-processing according to the present embodiment is binding or a binding process as a “stapling process” to bind, with staples, a plurality of the sheets P on each of which an image is formed as a bundle of sheets P (i.e., sheet bundle). In the following description, the bundle of sheets P as a bundle of recording media may be referred to as a “sheet bundle Pb.”

More specifically, the “crimp binding process” according to the present embodiment is a process called “crimp binding” to apply pressure to the binding position corresponding to a part of the sheet bundle Pb to deform (pressure-deform) the binding position and bind the sheet bundle Pb. The binding that can be executed by the post-processing apparatus 3 includes edge binding and saddle binding. The edge binding is a process to bind an end (including an edge) of the sheet bundle Pb. The saddle binding is a process to bind the center of the sheet bundle Pb.

The post-processing apparatus 3 includes the conveyance roller pairs 10 to 19 serving as a conveyor and a switching claw 20. The conveyance roller pairs 10 to 19 convey, inside the post-processing apparatus 3, the sheet P supplied from the image forming apparatus 2. Specifically, the conveyance roller pairs 10 to 13 convey the sheet P along a first conveyance passage Ph1. The conveyance roller pairs 14 and 15 convey the sheet P along a second conveyance passage Ph2. The conveyance roller pairs 16 to 19 convey the sheet P along a third conveyance passage Ph3.

The first conveyance passage Ph1 is a passage extending to an output tray 21 from a supply port through which the sheet P is supplied from the image forming apparatus 2. The second conveyance passage Ph2 is a passage branching from the first conveyance passage Ph1 between the conveyance roller pairs 11 and 14 in a conveyance direction and extending to an output tray 26 via an internal tray 22. The third conveyance passage Ph3 is a passage branching from the first conveyance passage Ph1 between the conveyance roller pairs 11 and 14 in the conveyance direction and extending to an output tray 30.

The switching claw 20 serving as a switcher is disposed at a branching position of the first conveyance passage Ph1 and the second conveyance passage Ph2. The switching claw 20 can be switched between a first position and a second position. The switching claw 20 in the first position guides the sheet P to be output to the output tray 21 through the first conveyance passage Ph1. The switching claw 20 in the second position guides the sheet P conveyed through the first conveyance passage Ph1 to the second conveyance passage Ph2. When a trailing end of the sheet P entering the second conveyance passage Ph2 passes through the conveyance roller pair 11, the conveyance roller pair 14 is rotated in the reverse direction to guide the sheet P to the third conveyance passage Ph3. The post-processing apparatus 3 further includes a plurality of sensors that detects the positions of the sheet P in the first conveyance passage Ph1, the second conveyance passage Ph2, and the third conveyance passage Ph3. Each of the plurality of sensors is indicated by a black triangle mark in FIG. 2.

The post-processing apparatus 3 includes the output tray 21. The sheet P that is output through the first conveyance passage Ph1 is placed on the output tray 21. Among the sheets P supplied from the image forming apparatus 2, the sheets P that are not bound are output to the output tray 21.

The post-processing apparatus 3 further includes the internal tray 22 serving as a receptacle, an end fence 23, side fences 24L and 24R, an edge binder 25, a stapling unit 155, and an output tray 26. The internal tray 22, the end fence 23, the side fences 24L and 24R, the edge binder 25, and the stapling unit 155 perform the edge binding on the sheet bundle Pb constructed of the plurality of sheets P conveyed through the second conveyance passage Ph2. Among the sheets P supplied from the image forming apparatus 2, the sheet bundle Pb subjected to the edge binding is output to the output tray 26.

The “edge binding” includes “parallel binding,” “oblique binding,” and “vertical binding.” The “parallel binding” is a process to bind the sheet bundle Pb along one side of the sheet bundle Pb parallel to the main scanning direction. The “oblique binding” is a process to bind a corner of the sheet bundle Pb. The “vertical binding” is a process to bind the sheet bundle Pb along one side of the sheet bundle Pb parallel to the conveyance direction.

In the following description, a direction in which the sheet P is conveyed from the conveyance roller pair 15 toward the end fence 23 is defined as a “conveyance direction” of the sheet P. In other words, the “conveyance direction” herein corresponds to a direction in which the sheet P that has been output from the image forming apparatus 2 is moved toward the output tray 26 by, for example, the conveyance roller pair 10 and then is moved toward the end fence 23 by the conveyance roller pair 15. A direction that is orthogonal to the conveyance direction and a thickness direction of the sheet P is defined as a “main scanning direction” or a “width direction of the sheet P.”

The sheets P that are sequentially conveyed through the second conveyance passage Ph2 are temporarily placed on the internal tray 22 serving as a receptacle. The end fence 23 aligns the position, in the conveyance direction, of the sheet P or the sheet bundle Pb placed on the internal tray 22. The side fences 24L and 24R align the position, in the main scanning direction, of the sheet P or the sheet bundle Pb placed on the internal tray 22. The edge binder 25 and the stapling unit 155 bind an end of the sheet bundle Pb aligned by the end fence 23 and the side fences 24L and 24R. Then, the conveyance roller pair 15 outputs the sheet bundle Pb subjected to the edge binding to the output tray 26.

The post-processing apparatus 3 further includes an end fence 27, a saddle binder 28, a sheet folding blade 29, and the output tray 30. The end fence 27, the saddle binder 28, and the sheet folding blade 29 perform the saddle binding on the sheet bundle Pb constructed of the sheets P that are conveyed through the third conveyance passage Ph3. Among the sheets P supplied from the image forming apparatus 2, the sheet bundle Pb subjected to the saddle stitching is output to the output tray 30.

The end fence 27 aligns the positions of the sheets P that are sequentially conveyed through the third conveyance passage Ph3, in a direction in which the sheets P are conveyed. The end fence 27 can move between a binding position where the end fence 27 causes the center of the sheet bundle Pb to face the saddle binder 28 and a folding position where the end fence 27 causes the center of the sheet bundle Pb to face the sheet folding blade 29. The saddle binder 28 binds the center of the sheet bundle Pb aligned by the end fence 27 at the binding position. The sheet folding blade 29 folds, in half, the sheet bundle Pb placed on the end fence 27 at the folding position and causes the conveyance roller pair 18 to sandwich the sheet bundle Pb. The conveyance roller pairs 18 and 19 output the sheet bundle Pb subjected to the saddle binding to the output tray 30.

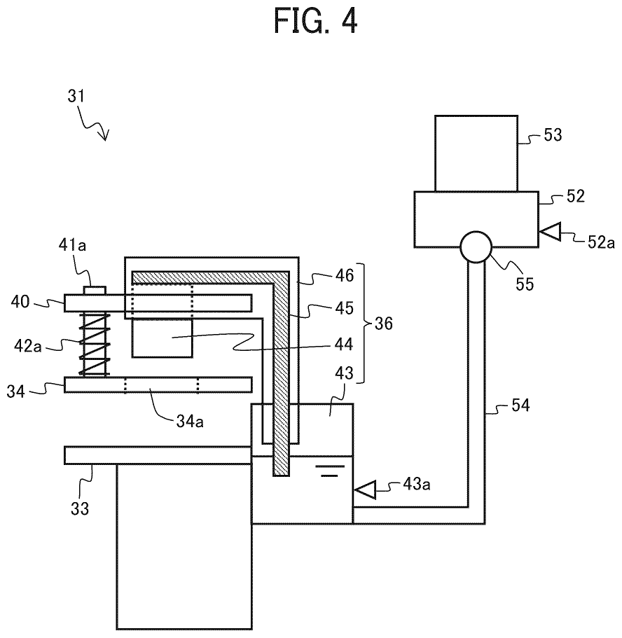

The post-processing apparatus 3 includes, in the edge binder 25, a first liquid-storage tank 43 serving as a first liquid storage and a first liquid supply portion 45 as a part of a liquid applier, as illustrated in FIG. 4. The post-processing apparatus 3 further includes a second liquid supply portion 54 as a part of a liquid supplier, a liquid supply pump 55 as a part of the liquid supplier, a second liquid-storage tank 53 as a part of a second liquid storage, and a second-liquid-storage-tank fixer 52 as a part of the second liquid storage, to replenish the first liquid-storage tank 43 with liquid. The liquid that is stored in the second liquid-storage tank 53 is supplied to the first liquid-storage tank 43 via the second-liquid-storage-tank fixer 52, the liquid supply pump 55, and the second liquid supply portion 54.

Now, a detailed description is given of the edge binder 25.

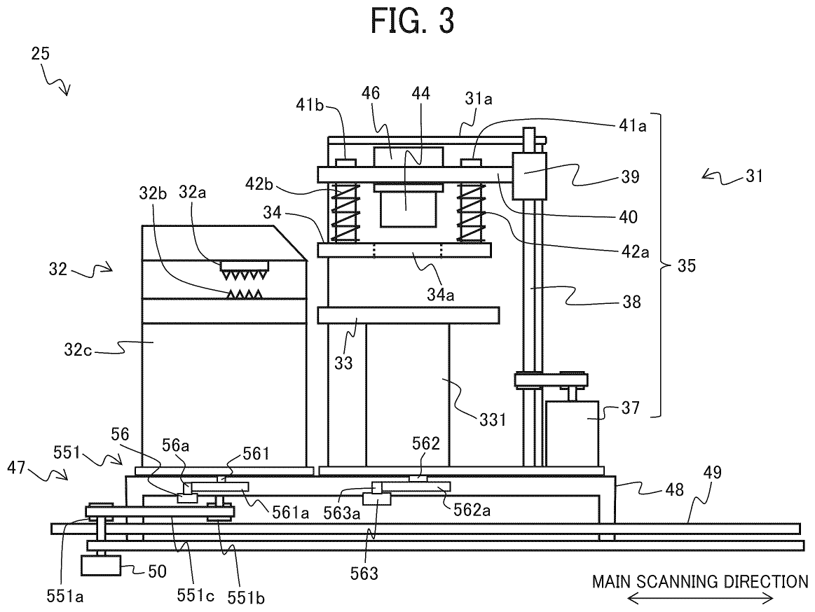

FIG. 3 is a schematic view of an upstream side of the edge binder 25 in the conveyance direction. The edge binder 25 performs liquid application and crimp binding. FIG. 4 is a schematic view of a liquid applier 31 of the edge binder 25 in the main scanning direction. As illustrated in FIG. 3, the edge binder 25 includes the liquid applier 31 and a crimper 32. The liquid applier 31 executes a processing operation related to the liquid application. The crimper 32 serves as a post-processing device and executes the crimp binding. The liquid applier 31 and the crimper 32 are disposed downstream from the internal tray 22 in the conveyance direction and adjacent to each other in the main scanning direction.

The liquid applier 31 applies liquid that is stored in a first liquid-storage tank 43 to the sheet P or the sheet bundle Pb placed on the internal tray 22. In the following description, the application of liquid to the sheet P or the sheet bundle Pb may be referred to as “liquid application” whereas a process to apply liquid may be referred to as a “liquid application process.”

More specifically, the liquid that is stored in the first liquid-storage tank 43 for the “liquid application” includes, as a main component, a liquid hydrogen-oxygen compound represented by the chemical formula H₂O. The liquid hydrogen-oxygen compound is at any temperature. For example, the liquid hydrogen-oxygen compound may be so-called warm water or hot water. The liquid hydrogen-oxygen compound is not limited to pure water. The liquid hydrogen-oxygen compound may be purified water or may contain ionized salts. The metal ion content ranges from so-called soft water to ultrahard water. In other words, the liquid hydrogen-oxygen compound is at any hardness.

The liquid that is stored in the first liquid-storage tank 43 may include an additive in addition to the main component. The liquid that is stored in the first liquid-storage tank 43 may include residual chlorine used as tap water. Preferably, for example, the liquid that is stored in the first liquid-storage tank 43 may include, as an additive, a colorant, a penetrant, a pH adjuster, a preservative such as phenoxyethanol, a drying inhibitor such as glycerin, or a combination thereof. Since water is used as a component of ink used for inkjet printers or ink used for water-based pens, such water or ink may be used for the “liquid application.”

The water is not limited to the specific examples described above. The water may be water in a broad sense such as hypochlorous acid water or an ethanol aqueous solution diluted for disinfection. However, tap water may be used simply to enhance the binding strength after the binding process because tap water is easy to obtain and store. A liquid including water as a main component as exemplified above enhances the binding strength of the sheet bundle Pb, as compared with a liquid of which the main component is not water.

As illustrated in FIGS. 3 and 4, the liquid applier 31 includes a lower pressure plate 33 serving as a receptacle for the sheet P or the sheet bundle Pb, an upper pressure plate 34, and a liquid-applier movement assembly 35. The components of the liquid applier 31 such as the lower pressure plate 33, the upper pressure plate 34, and the liquid-applier moving motor 37 are held by a liquid application frame 31a and a base 48.

The lower pressure plate 33 and the upper pressure plate 34 are disposed downstream from the internal tray 22 in the conveyance direction. The sheets P or the sheet bundle Pb that is placed on the internal tray 22 is also placed on the lower pressure plate 33. The lower pressure plate 33 is disposed on a lower-pressure-plate holder 331. The upper pressure plate 34 is movable in the thickness direction of the sheet P or the sheet bundle Pb at a position where the upper pressure plate 34 faces the sheet P or the sheet bundle Pb placed on the internal tray 22. In other words, the lower pressure plate 33 and the upper pressure plate 34 are disposed to face each other in the thickness direction of the sheet P or the sheet bundle Pb with the sheet P or the sheet bundle Pb placed on the internal tray 22 and interposed between the lower pressure plate 33 and the upper pressure plate 34. In the following description, the thickness direction of the sheet P or the sheet bundle Pb may be referred to simply as “thickness direction.” The upper pressure plate 34 has a through hole 34a penetrating in the thickness direction at a position where the through hole 34a faces an end of a liquid application member 44, which is a part of the liquid applier 31, held via a holder 46 attached to a base plate 40.

The liquid-applier movement assembly 35 moves the upper pressure plate 34, the base plate 40, the holder 46, the liquid application member 44, the first liquid supply portion 45, and the first liquid-storage tank 43 in the thickness direction of the sheet P or the sheet bundle Pb. The liquid-applier movement assembly 35 according to the present embodiment moves the upper pressure plate 34, the base plate 40, the first liquid-storage tank 43, the liquid application member 44, the first liquid supply portion 45, and the holder 46 in conjunction with each other (in a unified way) by a single liquid-applier moving motor 37. The liquid-applier movement assembly 35 includes, for example, the liquid-applier moving motor 37, a trapezoidal screw 38, a nut 39, the base plate 40, columns 41a and 41b, and coil springs 42a and 42b.

The liquid-applier moving motor 37 generates a driving force to move the upper pressure plate 34, the base plate 40, the holder 46, the liquid application member 44, the first liquid supply portion 45, and the first liquid-storage tank 43. The trapezoidal screw 38 extends in the thickness direction of the sheet P or the sheet bundle Pb and is supported by the liquid application frame 31a of the liquid applier 31 so as to be rotatable in the forward and reverse directions. The trapezoidal screw 38 is coupled to an output shaft of the liquid-applier moving motor 37 via, for example, a pulley and a belt. The nut 39 is screwed to the trapezoidal screw 38. The trapezoidal screw 38 is rotated in the forward and reverse directions by the driving force transmitted from the liquid-applier moving motor 37. The rotation of the trapezoidal screw 38 causes the nut 39 to reciprocate on the trapezoidal screw 38.

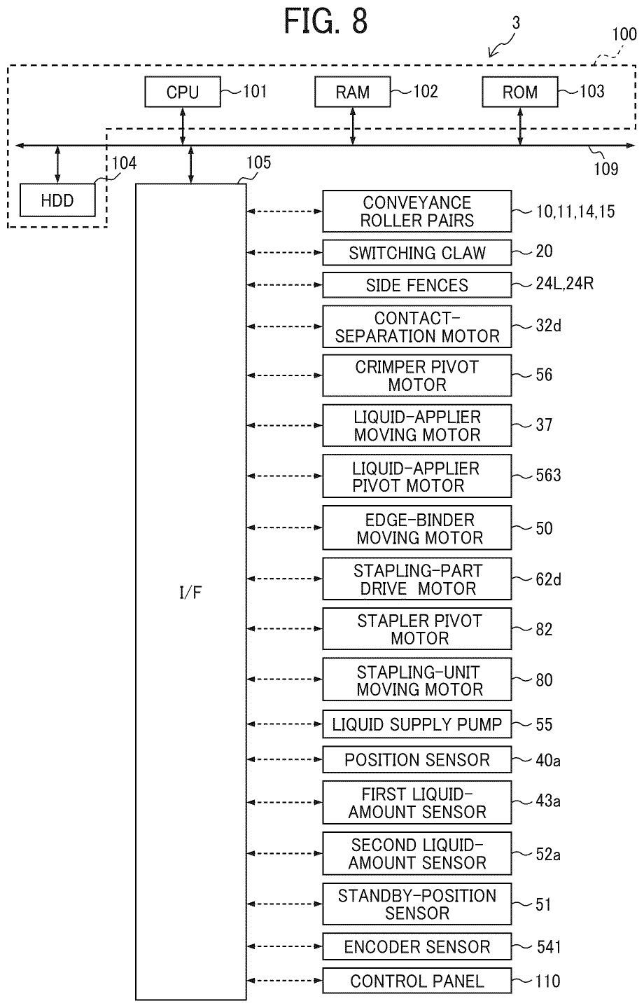

The base plate 40 is positioned apart from the upper pressure plate 34. The base plate 40 holds the liquid application member 44 with the end of the liquid application member 44 projecting from the base plate 40 toward the upper pressure plate 34. The base plate 40 is coupled to the trapezoidal screw 38 via the nut 39 so as to reciprocate along the trapezoidal screw 38 when the trapezoidal screw 38 rotates in the forward and reverse directions. The position of the base plate 40 in the thickness direction of the sheet P or the sheet bundle Pb is detected by a position sensor 40a illustrated in FIG. 8.

The columns 41a and 41b project from the base plate 40 toward the upper pressure plate 34 around the end of the liquid application member 44. The columns 41a and 41b are movable relative to the base plate 40 in the thickness direction. The columns 41a and 41b hold the upper pressure plate 34 with the respective ends closer to the lower pressure plate 33 than the other ends of the columns 41a and 41. The other ends of the columns 41a and 41 are provided with stoppers that prevent the columns 41a and 41b from being removed from the base plate 40. The coil springs 42a and 42b are fitted around the columns 41a and 41b, respectively, between the base plate 40 and the upper pressure plate 34. The coil springs 42a and 42b bias the upper pressure plate 34 and the columns 41a and 41b toward the lower pressure plate 33 with respect to the base plate 40.

The liquid applier 31 applies liquid to the sheet P or the sheet bundle Pb placed on the internal tray 22. More specifically, the liquid applier 31 brings the liquid application member 44 into contact with the sheet P or the sheet bundle Pb to apply the liquid to at least one sheet P of the sheet bundle Pb.

The liquid applier 31 includes a first liquid-amount sensor 43a serving as a first liquid detector, the first liquid-storage tank 43, the liquid application member 44, the first liquid supply portion 45, and the holder 46. The first liquid-storage tank 43 stores the liquid to be applied to the sheet P or the sheet bundle Pb. The amount of liquid that is stored in the first liquid-storage tank 43 is detected by the first liquid-amount sensor 43a. The first liquid-storage tank 43 is coupled to the base plate 40 via the holder 46.

The liquid application member 44 and the first liquid supply portion 45 disposed in close contact with the liquid application member 44 are both held by the holder 46. The holder 46 is held by the base plate 40. The first liquid supply portion 45 has a first end in close contact with the liquid application member 44 and a second end immersed in the liquid stored in the first liquid-storage tank 43. In other words, the second end of the first liquid supply portion 45 corresponds to an immersion portion that sucks up the liquid and supplies the liquid to the liquid application member 44. Each of the liquid application member 44 and the first liquid supply portion 45 is made of a material having a relatively high liquid absorption (for example, sponge or fiber) such as an elastic resin formed of open cells. Accordingly, when the other second end of the first liquid supply portion 45 is immersed in the stored liquid, the liquid is sucked up by capillary action. As a result, the first liquid supply portion 45 and the liquid application member 44 are filled with the liquid.

A liquid-applier shaft 562 including a drive transmission gear 562a is fixed to a bottom face of the liquid application frame 31a that holds the components of the liquid applier 31. The liquid-applier shaft 562 and the drive transmission gear 562a are held by the base 48 on which the liquid application frame 31a is disposed, so as to be rotatable in the forward and reverse directions. The drive transmission gear 562a meshes with an output gear 563a of a liquid-applier pivot motor 563. The liquid applier 31 can be rotated in the forward and reverse directions about the liquid-applier shaft 562 on the base 48 by a driving force transmitted from the liquid-applier pivot motor 563 to the liquid-applier shaft 562 via the output gear 563a and the drive transmission gear 562a.

Now, a description is given of the configuration of the crimper 32.

The crimper 32 (serving as post-processing device) presses and deforms a portion of the sheet bundle Pb with serrate upper crimping teeth 32a and lower crimping teeth 32b, and crimps sheets P at the portion to bind the sheet bundle Pb. In other words, the crimper 32 binds the sheet bundle Pb without staples. The components of the crimper 32 such as the upper crimping teeth 32a and the lower crimping teeth 32b are disposed on a crimping frame 32c. In the following description, such a way of pressing and deforming a given position on the sheet bundle Pb to bind the sheet bundle Pb may be referred to as “crimp binding.” In other words, the crimper 32 crimps and binds the sheet bundle Pb or performs the crimp binding on the sheet bundle Pb.

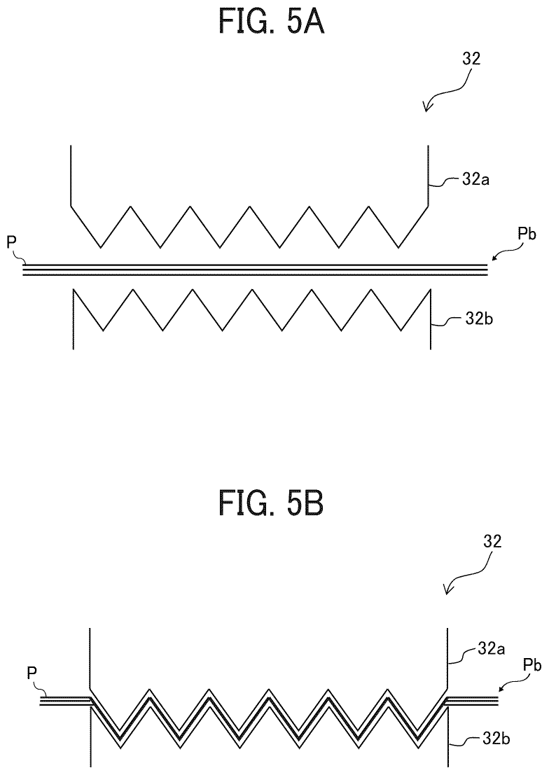

FIGS. 5A and 5B are schematic diagrams illustrating the configuration of the crimper 32. As illustrated in FIGS. 5A and 5B, the crimper 32 includes the upper crimping teeth 32a and the lower crimping teeth 32b. The upper crimping teeth 32a and the lower crimping teeth 32b are disposed to face each other in the thickness direction of the sheet bundle Pb to sandwich the sheet bundle Pb placed on the internal tray 22. The upper crimping teeth 32a and the lower crimping teeth 32b have respective serrate faces facing each other. The serrate face of each of the upper crimping teeth 32a and the lower crimping teeth 32b includes concave portions and convex portions alternately formed. The concave portions and the convex portions of the upper crimping teeth 32a are shifted from those of the lower crimping teeth 32b such that the upper crimping teeth 32a are engaged with the lower crimping teeth 32b. The upper crimping teeth 32a and the lower crimping teeth 32b are brought into contact with and separated from each other by a driving force of a contact-separation motor 32d illustrated in FIG. 8.

In the process of supplying the sheets P of the sheet bundle Pb to the internal tray 22, the upper crimping teeth 32a and the lower crimping teeth 32b are apart from each other as illustrated in FIG. 5A. When all the sheets P of the sheet bundle Pb are placed on the internal tray 22, the upper crimping teeth 32a and the lower crimping teeth 32b are engaged with each other to press and deform the sheet bundle Pb in the thickness direction as illustrated in FIG. 5B. As a result, the sheet bundle Pb that has been placed on the internal tray 22 is crimped and bound. The sheet bundle Pb thus crimped and bound is output to the output tray 26 by the conveyance roller pair 15.

The configuration of the crimper 32 as a crimping assembly is not limited to the configuration of a moving assembly exemplified in the present embodiment, and may be any other suitable structure in which the upper crimping teeth 32a and the lower crimping teeth 32b of the crimping assembly engage with each other. For example, the crimping assembly may bring the upper crimping teeth 32a and the lower crimping teeth 32b into contact with each other and separate the upper crimping teeth 32a and the lower crimping teeth 32b from each other with a link mechanism and a driving source that simply rotates forward or that rotates forward and backward (for example, the crimping assembly disclosed in Japanese Patent No. 6057167). Alternatively, the crimping assembly may employ a linear motion system to linearly bring the upper crimping teeth 32a and the lower crimping teeth 32b into contact with each other and separate the upper crimping teeth 32a and the lower crimping teeth 32b from each other with a screw assembly that converts the forward and backward rotational motions of a driving source into linear reciprocating motion.

As illustrated in FIG. 3, the edge binder 25 includes an edge-binder movement assembly 47. The edge-binder movement assembly 47 moves the edge binder 25 (in other words, the liquid applier 31 and the crimper 32) in the main scanning direction along the downstream end of the sheet P, which is placed on the internal tray 22, in the conveyance direction. The edge-binder movement assembly 47 includes, for example, the base 48, a guide shaft 49, the edge-binder moving motor 50, a driving force transmission assembly 551, and a standby-position sensor 51, which is illustrated in FIG. 8.

The liquid applier 31 and the crimper 32 are attached to the base 48 such that the liquid applier 31 and the crimper 32 are adjacent to each other in the main scanning direction. The guide shaft 49 extends in the main scanning direction at a position downstream from the internal tray 22 in the conveyance direction. The guide shaft 49 supports the base 48 such that the base 48 can move in the main scanning direction. The edge-binder moving motor 50 generates a driving force to move the edge binder 25. The edge-binder moving motor 50 generates a driving force to move the edge binder 25. The driving force transmission assembly 551 transmits the driving force of the edge-binder moving motor 50 to the base 48 via pulleys 551a and 551b and a timing belt 551c.

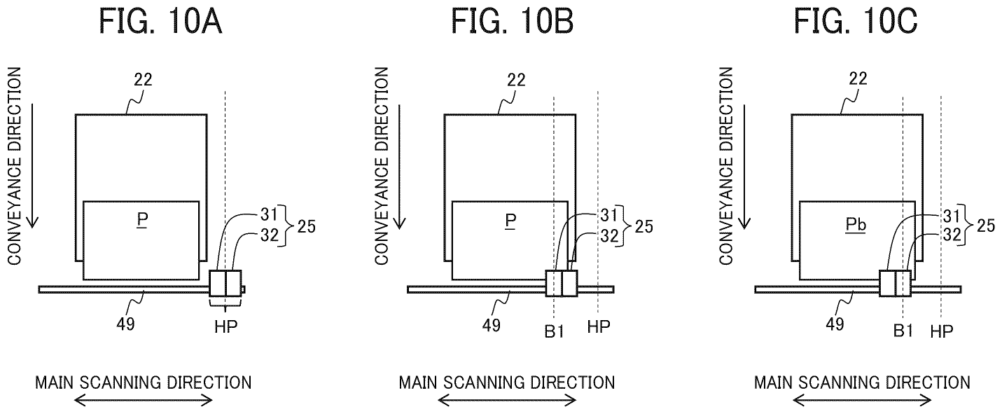

As a result, the liquid applier 31 and the crimper 32 integrated by the base 48 move in the main scanning direction along the guide shaft 49. The positions of the liquid applier 31 and the crimper 32 may be ascertained with, for example, an encoder sensor 541 (see FIG. 8) attached to an output shaft of the edge-binder moving motor 50. The standby-position sensor 51 (see FIG. 8) detects the arrival of the edge binder 25 at a standby position HP illustrated in FIG. 10A.

A crimper shaft 561 including a drive transmission gear 561a is fixed to a bottom face of the crimping frame 32c that holds the components of the crimper 32. The crimper shaft 561 and the drive transmission gear 561a are held by the base 48 on which the crimping frame 32c is disposed, so as to be rotatable in the forward and reverse directions. The drive transmission gear 561a meshes with an output gear 56a of a crimper pivot motor 56. The crimper 32 can be rotated in the forward and reverse directions about the crimper shaft 561 on the base 48 by a driving force transmitted from the crimper pivot motor 56 to the crimper shaft 561 via the output gear 56a and the drive transmission gear 561a.

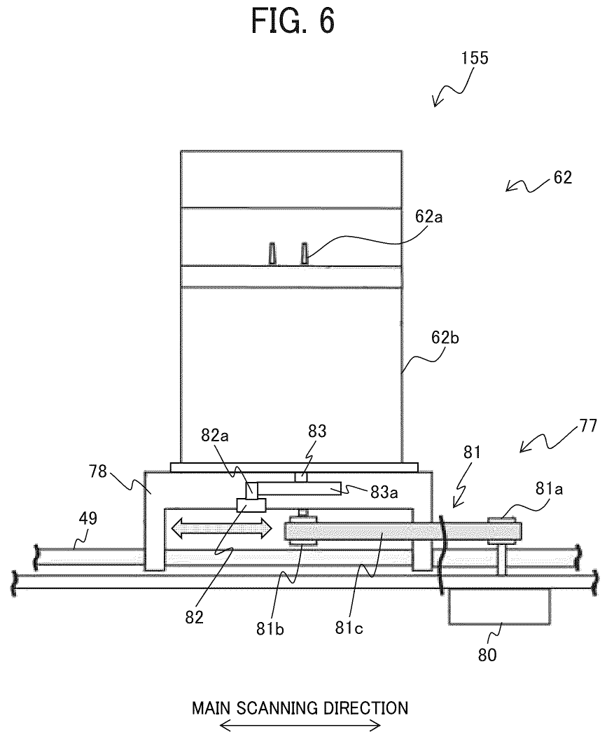

Specifically, a detailed description is now given of the stapling unit 155 having a function of executing a stapling process. FIG. 6 is a schematic view of an upstream side of the stapling unit 155 in the conveyance direction. The stapling unit 155 includes a stapler 62 that binds the sheet bundle Pb with staples. The stapler 62 is disposed downstream from the internal tray 22 in the conveyance direction and apart from the edge binder 25 in the main scanning direction.

The stapler 62 serving as a post-processing device has a configuration of performing so-called “stapling” (i.e., stapling process) to bind the sheet bundle Pb with a staple or staples. More specifically, the stapler 62 includes a stapling-part drive motor 62d illustrated in FIG. 8. The stapling-part drive motor 62d drives a stapling part 62a. The driving force of the stapling-part driving motor 62d causes a staple loaded in the stapling part 62a to penetrate through a sheet bundle Pb to bind the sheet bundle Pb. Since the stapler 62 has a typical configuration, a detailed description thereof will be omitted unless otherwise required.

As illustrated in FIG. 6, the stapling unit 155 includes a stapling-unit movement assembly 77. The stapling-unit movement assembly 77 moves the stapling unit 155 in the main scanning direction along a downstream end in the conveyance direction of the sheet P or the sheet bundle Pb placed on the internal tray 22. The stapling-unit movement assembly 77 includes, for example, a base 78, the guide shaft 49, a stapling-unit moving motor 80, and a driving force transmission assembly 81. The driving force transmission assembly 81 transmits a driving force of the stapling-unit moving motor 80 to the base 78 via pulleys 81a and 81b and a timing belt 81c. A stapler shaft 83 including a drive transmission gear 83a is fixed to a bottom face of a stapling frame 62b that holds the components of the stapler 62. The stapler shaft 83 and the drive transmission gear 83a are held by the base 78 on which the stapling frame 62b is disposed, so as to be rotatable in the forward and reverse directions. The drive transmission gear 83a meshes with an output gear 82a of a stapler pivot motor 82. The stapler 62 can be rotated in the forward and reverse directions about the stapler shaft 83 on the base 78 by a driving force transmitted from the stapler pivot motor 82 to the stapler shaft 83 via the output gear 82a and the drive transmission gear 83a.

The edge binder 25 and the stapling unit 155 are supported by the common guide shaft 49. The edge-binder movement assembly 47 and the stapling-unit movement assembly 77 move the edge binder 25 and the stapling unit 155 in the main scanning direction along the common guide shaft 49. The edge-binder movement assembly 47 and the stapling-unit movement assembly 77 can independently move the edge binder 25 and the stapling unit 155.

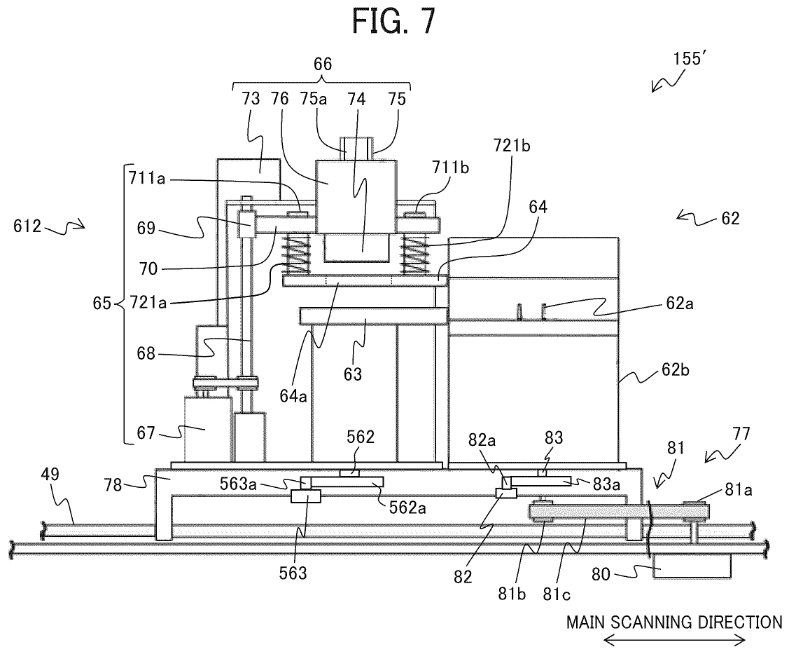

FIG. 7 illustrates a stapling unit 155′ as a modification of the stapling unit 155. Specifically, FIG. 7 is a schematic view of an upstream side of the stapling unit 155′ in the conveyance direction. The stapling unit 155′ is different from the stapling unit 155 in that the stapling unit 155′ includes a second liquid applier 612 in addition to the stapler 62. As illustrated in FIG. 7, the stapling unit 155′ includes the second liquid applier 612 and the stapler 62. The second liquid applier 612 and the stapler 62 are disposed downstream from the internal tray 22 in the conveyance direction and adjacent to each other in the main scanning direction.

The second liquid applier 612 executes “liquid application” of applying liquid (e.g., water) stored in a third liquid-storage tank 73 to the sheet P or the sheet bundle Pb supported on the internal tray 22. A given area including a position to which the liquid is applied on the sheet P or the sheet bundle Pb by the second liquid applier 612 corresponds to a binding position to be stapled. As illustrated in FIG. 7, the second liquid applier 612 includes a second lower pressure plate 63, a second upper pressure plate 64, a second liquid-applier movement assembly 65, and a second liquid application assembly 66. The second liquid-applier movement assembly 65 includes, for example, a second liquid-applier movement motor 67, a second trapezoidal screw 68, a second nut 69, a second base plate 70, second columns 711a and 711b, and second coil springs 721a and 721b. The second liquid application assembly 66 includes the third liquid-storage tank 73, a second liquid application member 74, a second liquid supply portion 75, and a second joint 76. Since the second liquid application assembly 66 and the liquid application assembly illustrated in FIGS. 3 and 4 have common configurations, redundant descriptions thereof will be omitted unless otherwise required. Since the configuration of the stapler 62 is like the configuration illustrated in FIG. 6, a detailed description thereof will be omitted unless otherwise required. Since the second liquid applier 612 and the liquid applier 31 that are illustrated in FIG. 3 have common pivot mechanisms, redundant descriptions thereof will be omitted unless otherwise required.

In the binding process, the stapling unit 155′ that is illustrated in FIG. 7 performs the liquid application process on the sheet P to loosen and soften the binding position, allowing the staple to easily pass through the sheet bundle Pb. As a result, the number of sheets to be bound per sheet bundle Pb is increased as compared with a case where the stapling process is performed without applying the liquid.

A description is given below of the control block of the post-processing apparatus 3. FIG. 8 is a diagram illustrating a hardware configuration of the post-processing apparatus 3. As illustrated in FIG. 8, the post-processing apparatus 3 includes a central processing unit (CPU) 101, a random access memory (RAM) 102, a read only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic unit and controls the overall operation of the post-processing apparatus 3. The RAM 102 is a volatile storage medium that allows data to be read and written at high speed. The CPU 101 uses the RAM 102 as a working area for data processing. The ROM 103 is a read-only non-volatile storage medium that stores programs such as firmware. The HDD 104 is a non-volatile storage medium that allows data to be read and written and has a relatively large storage capacity. The HDD 104 stores, e.g., an operating system (OS), various control programs, and application programs.

By an arithmetic function of the CPU 101, the post-processing apparatus 3 processes, for example, a control program stored in the ROM 103 and an information processing program (application program) loaded into the RAM 102 from a storage medium such as the HDD 104. Such processing configures a software controller including various functional modules of the post-processing apparatus 3. The software controller thus configured cooperates with hardware resources of the post-processing apparatus 3 to construct functional blocks that implement functions of the post-processing apparatus 3. In other words, the CPU 101, the RAM 102, the ROM 103, and the HDD 104 construct a controller 100 that controls the operation of the post-processing apparatus 3.

The I/F 105 is an interface that connects the conveyance roller pairs 10, 11, 14, and 15, the switching claw 20, the side fences 24L and 24R, the contact-separation motor 32d, the crimper pivot motor 56, the liquid-applier moving motor 37, the edge-binder moving motor 50, the stapling-part drive motor 62d, the stapler pivot motor 82, the stapling-unit moving motor 80, the liquid supply pump 55, the position sensor 40a, the first liquid-amount sensor 43a, the second liquid-amount sensor 52a, the standby-position sensor 51, the encoder sensor 541, and a control panel 110 to the common bus 109. The controller 100 operates, via the I/F 105, the conveyance roller pairs 10, 11, 14, and 15, the switching claw 20, the side fences 24L and 24R, the contact-separation motor 32d, the crimper pivot motor 56, the liquid-applier moving motor 37, the edge-binder moving motor 50, the stapling-part drive motor 62d, the stapler pivot motor 82, the stapling-unit moving motor 80, and the liquid supply pump 55. On the other hand, the controller 100 acquires detection results from the position sensor 40a, the first liquid-amount sensor 43a, the second liquid-amount sensor 52a, the standby-position sensor 51, and the encoder sensor 541. Although FIG. 8 illustrates the components related to the stapling unit 155 and the edge binder 25 that executes the edge binding, the components related to the saddle binder 28 that executes the saddle binding are controlled by the controller 100 like the components related to the stapling unit 155 and the edge binder 25 that executes the edge binding.

As illustrated in FIG. 1, the image forming apparatus 2 includes the control panel 110. The control panel 110 includes an input unit that receives inputs from an operator and a display serving as a notifier that notifies the operator of information. Thus, the control panel 110 serves as an input device. The input unit includes, for example, physical input buttons and a touch panel superimposed on the display. The control panel 110 acquires information from the operator through the input unit and provides information to the operator through the display. A specific example of the notifier is not limited to the display and may be a light emitting diode (LED) lamp or a speaker. The post-processing apparatus 3 may include the control panel 110 like the control panel 110 described above.

As described above, the post-processing apparatus 3 implements a function of performing operation control related to the liquid application by software (control programs) executed by the CPU 101 with hardware resources included in the controller 100.

A description is given below of a binding process.

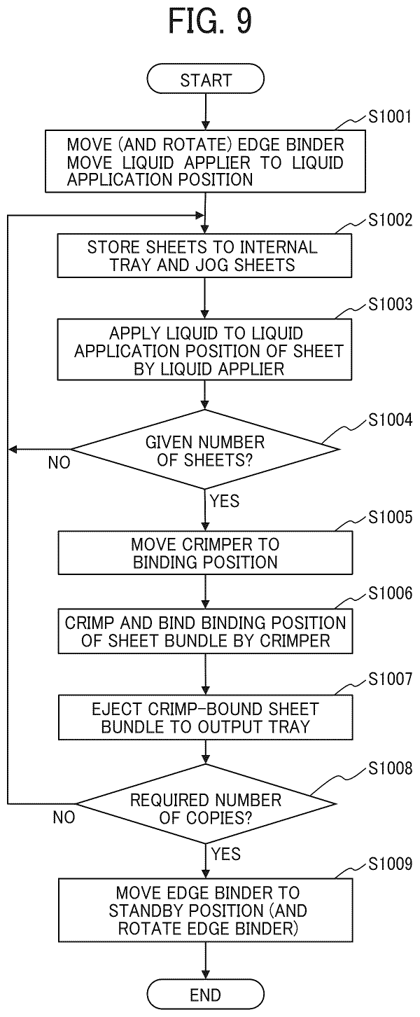

Specifically, a description is now given of a flow of a binding process executed by the edge binder 25 included in the post-processing apparatus 3. FIG. 9 is a flowchart of the binding process. FIGS. 10A, 10B, and 10C are diagrams illustrating the positions of the liquid applier 31 and the crimper 32 during the binding process of FIG. 9. FIGS. 10A, 10B, and 10C do not illustrate changes in the postures of the liquid applier 31 and the crimper 32. For example, the controller 100 starts the binding process illustrated in FIG. 9 when the controller 100 acquires an instruction to execute the binding process from the image forming apparatus 2. In the following description, the instruction to execute the binding process may be referred to as a “binding command.”

The binding command includes, for example, the type of the sheet P (i.e., information affecting the spread of liquid, such as material and thickness), the number of sheets P of the sheet bundle Pb, the number of sheet bundles Pb to be bound, the binding position on the sheet bundle Pb, and the binding posture of the edge binder 25. In the following description, the number of sheets P of the sheet bundle Pb may be referred to as “given number” whereas the number of sheet bundles Pb to be bound may be referred to as “requested number of copies.” The liquid applier 31 and the crimper 32 are in the parallel binding posture and at the standby position HP as illustrated in FIG. 10A at the start of the binding process. As illustrated in FIG. 10A, the standby position HP is away in the width direction from the sheet P placed on the internal tray 22.

When the posture that is instructed by the binding command is the “oblique binding posture,” the controller 100 drives the crimper pivot motor 56 to rotate the liquid applier 31 and the crimper 32 of the edge binder 25 into the oblique binding posture. Alternatively, when the posture that is instructed by the binding command is the “oblique binding posture,” only the crimper 32 may be rotated to the oblique binding posture while the liquid applier 31 may not be rotated. In this case, the driving assembly may be simplified as compared with a case where both the liquid applier 31 and the crimper 32 are rotated, and thus effects of cost reduction, downsizing of the apparatus, and reduction of failure of the device are exhibited.

On the other hand, when the posture that is instructed by the binding command is the “parallel binding posture,” the controller 100 omits the aforementioned operation of rotating the liquid applier 31 and the crimper 32 of the edge binder 25 to the oblique binding posture. In step S1001, the controller 100 drives the edge-binder moving motor 50 to move the edge binder 25 in the main scanning direction so that the liquid applier 31 faces a binding position B1 instructed by the binding command. The controller 100 executes the operation of step S1001 before a first sheet P is conveyed to the internal tray 22 by the conveyance roller pairs 10, 11, 14, and 15.

In step S1002, the controller 100 rotates the conveyance roller pairs 10, 11, 14, and 15 to accommodate the sheet P on which an image is formed by the image forming apparatus 2 in the internal tray 22. in S1002, the controller 100 also moves the side fences 24L and 24R to align (jog) the position of the sheet P held in the internal tray 22 in the main scanning direction. This alignment of the position of a sheet bundle is also referred to as jogging.

In step S1003, the controller 100 causes the liquid applier 31, which is placed at the position facing the binding position B1, to apply liquid to the binding position B1 on the sheet P, which has been supported on the internal tray 22 in the immediately preceding step S1002. In other words, the controller 100 drives the liquid-applier moving motor 37 to cause the liquid application member 44 to contact the binding position B1 on the sheet P supported on the internal tray 22 (see FIG. 10B).

In step S1004, the controller 100 determines whether the number of sheets accommodated in the internal tray 22 has reached a given number of sheets indicated by the binding command. When the controller 100 determines that the number of sheets P accommodated in the internal tray 22 has not reached the given number of sheets (NO in step S1004), the controller 100 executes the operations of steps S1002 and S1003 again. In other words, the controller 100 executes the processing of steps S1002 and S1003 each time a sheet P is conveyed to the internal tray 22 by the conveyance roller pairs 10, 11, 14, and 15. The liquid applier 31 may apply liquid to all or some of the sheets P of the sheet bundle Pb.

When the controller 100 determines that the number of sheets P accommodated in the internal tray 22 has reached the given number (YES in step S1004), in step S1005, the controller 100 drives the edge-binder moving motor 50 to cause the edge binder 25 to move in the main scanning direction so that the crimper 32 faces the binding position B as illustrated in FIG. 10C.

In step S1006, the controller 100 causes the crimper 32 to perform crimp binding on the sheet bundle Pb placed on the internal tray 22. In step S1007, the controller 100 causes the conveyance roller pair 15 to eject the sheet bundle Pb subjected to crimp binding by the crimper 32 to the output tray 26. Specifically, the controller 100 drives the contact-separation motor 32d to cause the upper crimping teeth 32a and the lower crimping teeth 32b to sandwich the binding position B1 on the sheet bundle Pb supported on the internal tray 22. The sheet bundle Pb is pressed and deformed between the upper crimping teeth 32a and the lower crimping teeth 32b. Thus, the crimper 32 crimps and binds the sheet bundle Pb. Then, the controller 100 rotates the conveyance roller pair 15 to output the sheet bundle Pb thus crimped and bound to the output tray 26.

The sheet bundle Pb that is supported on the internal tray 22 has the crimp binding area sandwiched between the upper crimping teeth 32a and the lower crimping teeth 32b in step S1006. The crimp binding area overlaps the liquid application area contacted by the leading end of the liquid application member 44 in step S1003. In other words, the crimper 32 crimps and binds an area to which liquid is applied by the liquid applier 31 on the sheet bundle Pb supported on the internal tray 22. The crimp binding area that is sandwiched by the upper crimping teeth 32a and the lower crimping teeth 32b may completely or partially overlaps the liquid application area contacted by the end of the liquid application member 44, to obtain a sufficient binding strength.

In step S1008, the controller 100 determines whether the number of sheet bundles Pb thus output has reached the requested number of copies indicated by the binding command. When the controller 100 determines that the number of sheet bundles Pb thus output has not reached the requested number of copies (NO in step S1008), the controller 100 executes the operations of step S1002 and the subsequent steps again. In other words, when NO in step S1008, the controller 100 repeats the operations of steps S1002 to S1007 until the number of sheet bundles Pb ejected to the output tray 26 reaches the requested number of copies.

By contrast, when the controller 100 determines that the number of sheet bundles Pb ejected to the output tray 26 has reached the requested number of copies (YES in step S1008), in step S1009, the controller 100 drives the edge-binder moving motor 50 to move the edge binder 25 to the standby position HP as illustrated in FIG. 10A. When the posture that is instructed by the binding command is the “oblique binding posture,” in step S1009, the controller 100 also drives the crimper pivot motor 56 to rotate the liquid applier 31 and the crimper 32 into the parallel binding posture. By contrast, when the posture that is instructed by the binding command is the “parallel binding posture,” the controller 100 skips the aforementioned operation of rotating the liquid applier 31 and the crimper 32 to the parallel binding posture. As a result, the liquid applier 31 and the crimper 32 return to the standby position HP position illustrated in FIG. 10A. In steps S1001 and S1009, the execution order of the movement in the main scanning direction and the rotation in the forward and reverse directions of the liquid applier 31 and the crimper 32 is not limited to the aforementioned order and may be reversed.

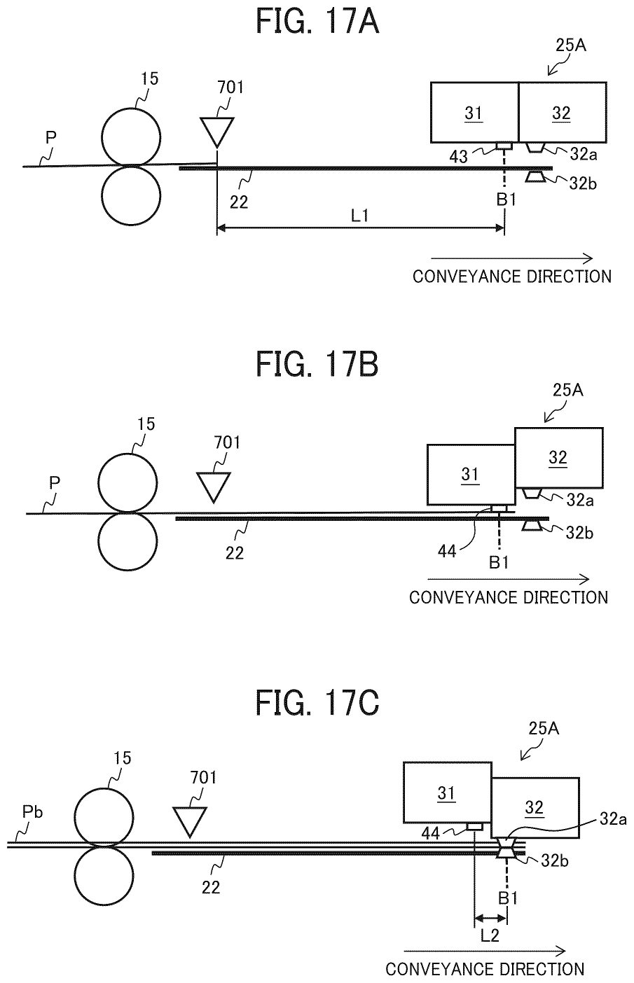

A description is given below of a modification of the edge binder 25 described above. The configuration of the edge binder 25 is not limited to the example of the above-described embodiment. FIGS. 17A, 17B, and 17C are diagrams illustrating the configuration of an edge binder 25A according to a modification of the above-described embodiment. Detailed descriptions will be omitted of common features of the above-described embodiment and the present modification. The following description is mainly given of the differences between the above-described embodiment and the present modification.

An edge binder 25A illustrated in FIGS. 17A, 17B, and 17C is different from the edge binder 25 of FIG. 3, in which the liquid applier 31 and the crimper 32 are disposed adjacent to each other in the main scanning direction, in that a liquid applier 31 and a crimper 32 illustrated in FIGS. 17A, 17B, and 17C are disposed adjacent to each other in the conveyance direction of a sheet P. More specifically, the liquid applier 31 is disposed upstream from the crimper 32 in the conveyance direction. Furthermore, as illustrated in FIG. 17A, on the upstream side of the liquid applier 31 in the conveyance direction, a medium sensor 701 is disposed that detects the leading end (the downstream end in the conveyance direction) of the sheet P conveyed by the conveyance roller pair 15.

As illustrated in FIG. 17B, the controller 100 causes the liquid applier 31 to apply liquid to the sheet P when the sheet P has been conveyed by the predetermined first conveyance amount L1 from the detection of the leading end of the sheet P by the medium sensor 701 (i.e., when the liquid application member 44 of the liquid applier 31 faces the binding position B1 of the sheet P). The controller 100 causes the liquid applier 31 illustrated in FIGS. 17A and 17B to repeatedly perform the liquid application operation on the plurality of sheets P of the sheet bundle Pb. When the liquid application to the plurality of sheets P of the sheet bundle Pb by the liquid applier 31 is completed, as illustrated in FIG. 17C, the controller 100 allows the crimper 32 to crimp and bind the sheet bundle Pb when the liquid applier 31 has conveyed the sheet bundle Pb by a predetermined second conveyance amount L2 after applying liquid to the sheet P (i.e., when the upper crimping teeth 32a and the lower crimping teeth 32b of the crimper 32 face the binding position B1). The first conveyance amount L1 and the second conveyance amount L2 are specified by, for example, a pulse signal output from a rotary encoder of the conveyance roller pair 15.

A description is given below of an operation of the liquid applier according to an embodiment of the present disclosure.

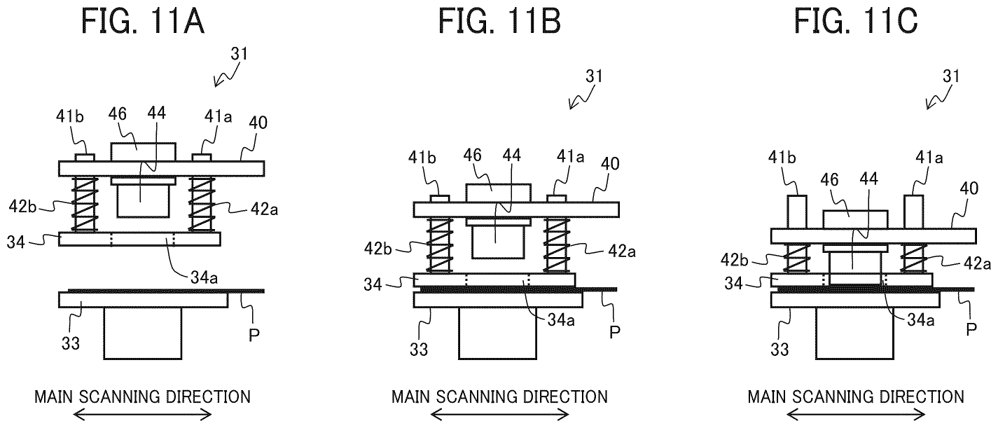

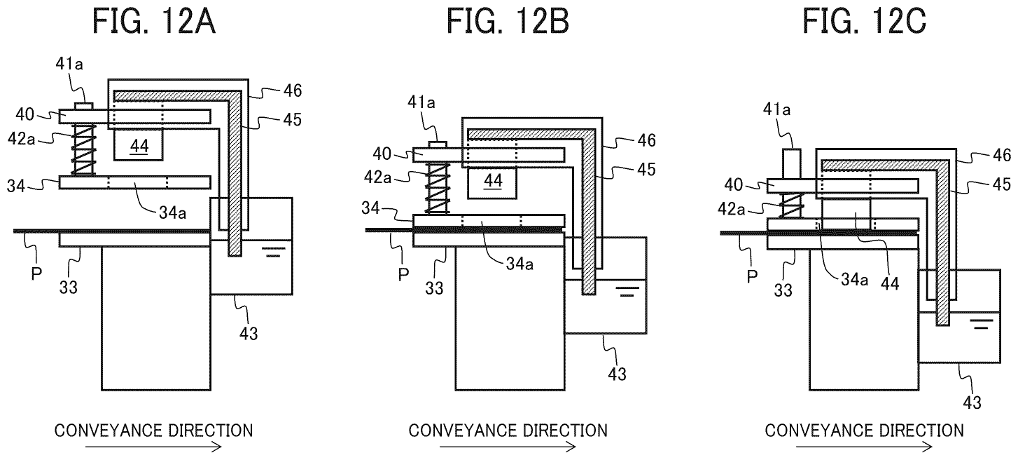

With reference to FIGS. 11A, 11B, and 11C and 12A, 12B, and 12C, a procedure is described in which the liquid applier 31 applies liquid to a sheet P. FIGS. 11A, 11B, and 11C are diagrams illustrating an operation of the liquid applier 31 as viewed from the upstream side in the conveyance direction. FIGS. 12A, 12B, and 12C are diagrams illustrating the operation of the liquid applier 31 viewed from the side on which the liquid applier 31 is disposed in the main scanning direction.

As illustrated in FIGS. 11A and 12A, before the liquid application to the sheet P (in other words, during the conveyance of the sheet P to the internal tray 22 by the conveyance roller pair 15), the upper pressure plate 34 and the liquid application member 44 are already separated from the upper surface of the sheet P placed on the internal tray 22 and the lower pressure plate 33. As a result, a sheet P newly supplied to the internal tray 22 by the conveyance roller pair 15 enters the space between the lower pressure plate 33 and the upper pressure plate 34 and is stacked on a sheet P already placed on the internal tray 22.

When the liquid-applier moving motor 37 is rotated in a first direction, the base plate 40 moves toward the lower pressure plate 33 together with the upper pressure plate 34, the columns 41a and 41b, the coil springs 42a and 42b, the first liquid-storage tank 43, the liquid application member 44, the first liquid supply portion 45, and the holder 46. As illustrated in FIGS. 11B and 12B, the upper pressure plate 34 comes into contact with the upper surface of the sheet P placed on the lower pressure plate 33. In other words, the sheet P placed on the internal tray 22 and the lower pressure plate 33 is pressed by the upper pressure plate 34. At this time, the liquid application member 44 is not yet in contact with the sheet P.

When the liquid-applier moving motor 37 is further rotated in the first direction from the states of FIGS. 11B and 12B, the coil springs 42a and 42b sandwiched between the upper pressure plate 34 and the base plate 40 are elastically compressed. Thus, while the upper pressure plate 34 presses the sheet P placed on the internal tray 22 and the lower pressure plate 33, the base plate 40 further moves toward the lower pressure plate 33 together with the first liquid-storage tank 43, the liquid application member 44, the first liquid supply portion 45, and the holder 46.

As illustrated in FIGS. 11C and 12C, the leading end (lower end) of the liquid application member 44 passes through the through hole 34a and contacts the sheet P. Thus, the liquid applier 31 executes liquid application to the sheet P by the liquid application member 44, with the sheet P being pressed by the upper pressure plate 34.

When the liquid-applier moving motor 37 is rotated in a second direction opposite to the first direction from the states of FIGS. 11C and 12C, the base plate 40 moves in the direction away from the lower pressure plate 33 together with the first liquid-storage tank 43, the liquid application member 44, the first liquid supply portion 45, and the holder 46. On the other hand, the upper pressure plate 34, while pressing the sheet P by the urging force of the coil springs 42a and 42b, does not move until the base plate 40 reaches the positions of FIG. 11B and FIG. 12B. After the base plate 40 reaches the positions of FIGS. 11B and 12B, the upper pressure plate 34, the columns 41a and 41b, and the coil springs 42a and 42b move in the direction away from the lower pressure plate 33 together with the base plate 40.

As illustrated in FIG. 12A, the lower end of the liquid application member 44 (i.e., a surface on which the liquid application member 44 contacts the sheet P or the bundle of sheets Pb in application of the liquid) is located higher than the position of a liquid level in the first liquid-storage tank 43 when the liquid is stored to a first upper limit value (i.e., an uppermost end position). The first liquid-storage tank 43 moves in conjunction with the movement of the liquid application member 44 (more specifically, moves with the liquid application member 44 as a single unit). As a result, as illustrated in FIGS. 12B and 12C, the position of the lower end of the liquid application member 44 and the uppermost end position of the liquid level in the first liquid-storage tank 43 constantly satisfy the relationship described above. In other words, the lower end of the moving range of the liquid application member 44 is located higher than the uppermost end position of the liquid level in the first liquid-storage tank 43. In still other words, as illustrated in FIGS. 6A to 6C, the surface of the liquid application member 44 that contacts the sheet P or the sheet bundle Pb in liquid application is always located higher than the uppermost end position of the liquid that is stored in the first liquid-storage tank 43 while the liquid application member 44 moves in a direction in which the liquid application member 44 contacts with or separates from the sheet P and the sheet bundle Pb. Such a configuration can prevent liquid leakage from the liquid application member 44 due to excessive supply of liquid sucked up from the first liquid-storage tank 43 by capillary action to the liquid application member 44. As a result, the liquid application member 44 can accurately apply a specified amount of liquid, which is predetermined by, for example, the type of sheet P, to the sheet P, thus allowing the binding strength of the sheet bundle Pb to be enhanced.

A description is given below of a liquid applier according to a modification of the above-described embodiment.

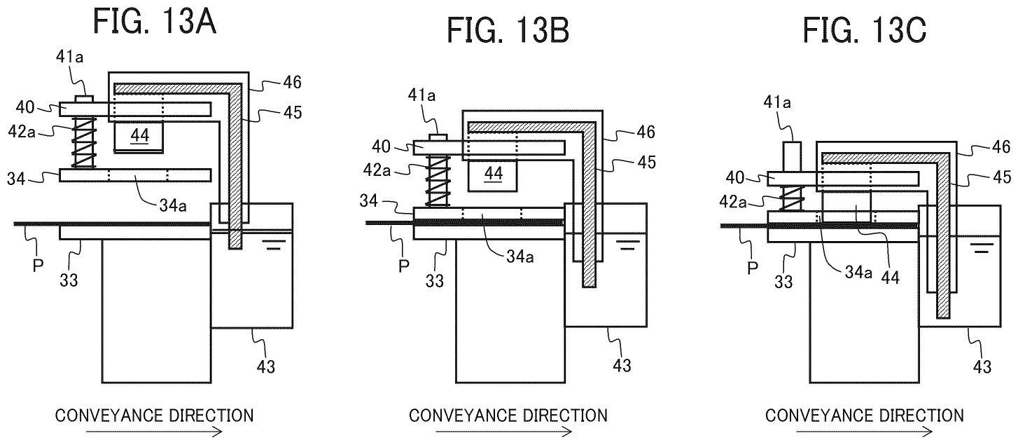

FIGS. 13A, 13B, and 13C are diagrams illustrating an operation of a liquid applier according to a first modification of the above-described embodiment, as viewed from the side on which the liquid applier is disposed in a main scanning direction. Detailed descriptions will be omitted of common features of the above-described embodiment and the present modification. The following description is mainly given of the differences between the above-described embodiment and the present modification. A first liquid-storage tank 43 according to the first modification is different from the above-described embodiment in that the first liquid-storage tank 43 is fixed to a liquid application frame 31a of a liquid applier 31 so as to hold a constant position regardless of movement of the liquid application member 44, and the other points are common to the above-described embodiment.

As illustrated in FIGS. 13A to 13C, the first modification is common to the above-described embodiment in the relationship between the position of the lower end of the liquid application member 44 and the position of the liquid level of the liquid stored in the first liquid-storage tank 43 when the liquid is stored to the first upper limit value. In short, the lower end of the moving range of the liquid application member 44 is located higher than the uppermost end position of the liquid stored in the first liquid-storage tank 43. In other words, as illustrated in FIGS. 13A to 13C, the surface of the liquid application member 44 that contacts the sheet P or the sheet bundle Pb in liquid application is always located higher than the uppermost end position of the liquid level in the first liquid-storage tank 43 while the liquid application member 44 moves in a direction in which the liquid application member 44 contacts with or separates from the sheet P and the sheet bundle Pb.

As in the first modification, fixing the first liquid-storage tank 43 reduces fluctuations of the liquid level of the liquid stored in the first liquid-storage tank 43. Thus, the accuracy in detection of the first liquid-amount sensor 43a can be enhanced in addition to the effect of preventing liquid leakage according to the embodiment of FIG. 6. In addition, the weight of the object (the component of the liquid applier 31) moved by the liquid-applier moving motor 37 decreases, thus allowing a reduction of the load on the liquid-applier moving motor 37. As a result, the liquid-applier moving motor 37 can be a low-output motor, thus allowing reduction of the size and cost of the apparatus.

A description is given below of a second liquid-storage tank according to an embodiment of the present disclosure.

As illustrated in FIG. 4, the post-processing apparatus 3 includes the second-liquid-storage-tank fixer 52, the second liquid-storage tank 53 as a second liquid storage, the second liquid supply portion 54, and the liquid supply pump 55, to supply liquid to the first liquid-storage tank 43. For example, the liquid is supplied to the first liquid-storage tank 43 in a way described below. However, the way of supplying the liquid to the first liquid-storage tank 43 is not limited to the following example. Alternatively, for example, an operator may directly replenish the first liquid-storage tank 43 with the liquid.

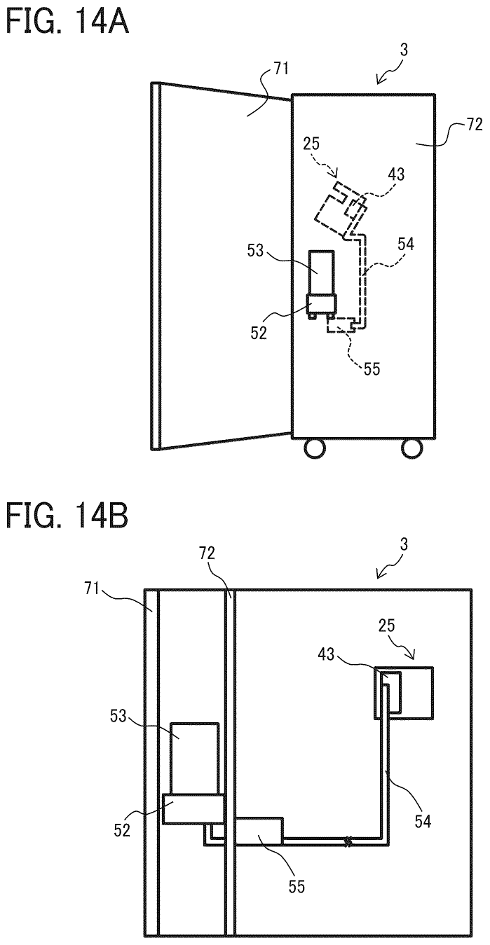

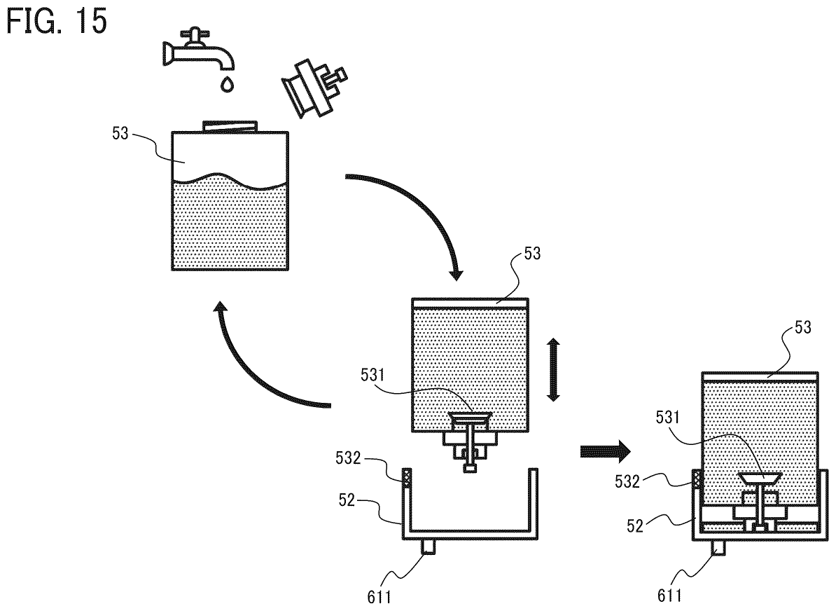

Referring now to FIGS. 14A, 14B, and 15, a description is given of the arrangement and configuration of the second liquid-storage tank 53. FIGS. 14A and 14B illustrate an example of the arrangement and configuration of the second liquid-storage tank 53 as the main tank. FIG. 14A illustrates the post-processing apparatus 3 with a cover (i.e., a front door 71) opened. FIG. 14B is a cross-sectional side view of the post-processing apparatus 3, illustrating the post-processing apparatus 3 with the cover (i.e., the front door 71) closed. As illustrated in FIGS. 14A and 14B, the second liquid-storage tank 53 is located so as to be accessible when the front door 71 of the post-processing apparatus 3 is opened. A main-body side plate 72 of the post-processing apparatus 3 is disposed between where the second liquid-storage tank 53 and the second-liquid-storage-tank fixer 52 are disposed and where the first liquid-storage tank 43 is disposed. The second-liquid-storage-tank fixer 52 is provided with a liquid drain plug 611. After the liquid remaining in the first liquid-storage tank 43 and the second liquid supply portion 54 is reversely fed to the second-liquid-storage-tank fixer 52, the liquid drain plug 611 is opened to discharge the liquid stored in the second-liquid-storage-tank fixer 61 from the inside of the post-processing apparatus 3. Thus, the liquid is prevented from being frozen during maintenance of the post-processing apparatus 3.

FIG. 15 illustrates the second liquid-storage tank 53 attachable to and detachable from the second-liquid-storage-tank fixer 52 and replenished with liquid. As illustrated in FIG. 14, the second liquid-storage tank 53 is attachable to and detachable from the second-liquid-storage-tank fixer 52 so as to be replenished with liquid. The second-liquid-storage-tank fixer 52 is provided with a mount sensor 532 to detect that the second liquid-storage tank 53 is mounted on second-liquid-storage-tank fixer 52. When the second liquid-storage tank 53 is not mounted on the second-liquid-storage-tank fixer 52, an outlet of the second liquid-storage tank 53 is closed by a liquid supply valve 531 so that the liquid does not leak. When the second liquid-storage tank 53 is mounted on the second-liquid-storage-tank fixer 52, the liquid supply valve 531 is pushed up and the liquid stored in the second liquid-storage tank 53 flows to the second-liquid-storage-tank fixer 52, allowing the liquid to be stored in the second-liquid-storage-tank fixer 52.

The second-liquid-storage-tank fixer 52 stores the liquid to be supplied to the first liquid-storage tank 43. The second-liquid-storage-tank fixer 52 is attached to the main-body side plate 72 of the post-processing apparatus 3 outside the moving range, in the main scanning direction, of the edge binder 25 including the liquid applier 31. The amount of liquid that is stored in the second-liquid-storage-tank fixer 52 is detected by a second liquid-amount sensor 52a serving as a second liquid detector.

The second liquid-storage tank 53, which is a liquid bottle, stores the liquid to be supplied to the second-liquid-storage-tank fixer 52. The second liquid-storage tank 53 is attachable to and detachable from the second-liquid-storage-tank fixer 52. When second liquid-storage tank 53 is attached to the second-liquid-storage-tank fixer 52, the liquid moves from the second liquid-storage tank 53 to the second-liquid-storage-tank fixer 52 until the amount of liquid in the second-liquid-storage-tank fixer 52 reaches a second upper-limit value. When the amount of liquid in the second-liquid-storage-tank fixer 52 reaches the second upper-limit value, the liquid stops moving from the second liquid-storage tank 53 to the second-liquid-storage-tank fixer 52.

The second liquid supply portion 54 couples the second-liquid-storage-tank fixer 52 and the first liquid-storage tank 43 to each other. The second liquid supply portion 54 supplies the liquid stored in the second-liquid-storage-tank fixer 52 to the first liquid-storage tank 43. The second liquid supply portion 54 is, for example, a pipe, a hose, or a combination thereof. The diameter (inner diameter) of the second liquid supply portion 54 is set to such a size that allows the speed at which the liquid is supplied from the second-liquid-storage-tank fixer 52 to the first liquid-storage tank 43 through the second liquid supply portion 54 to be higher than the speed at which the liquid is supplied from the first liquid-storage tank 43 to the liquid application member 44 through the first liquid supply portion 45. In the following description, the speed at which the liquid is supplied from the first liquid-storage tank 43 to the liquid application member 44 through the first liquid supply portion 45 may be referred to a first supply speed whereas the speed at which the liquid is supplied from the second-liquid-storage-tank fixer 52 to the first liquid-storage tank 43 through the second liquid supply portion 54 may be referred to as a second supply speed.

The liquid supply pump 55 is attached to the main-body side plate 72 of the post-processing apparatus 3 together with the second-liquid-storage-tank fixer 52. The liquid supply pump 55 supplies (pumps) the liquid stored in the second-liquid-storage-tank fixer 52 to the first liquid-storage tank 43 through the second liquid supply portion 54.

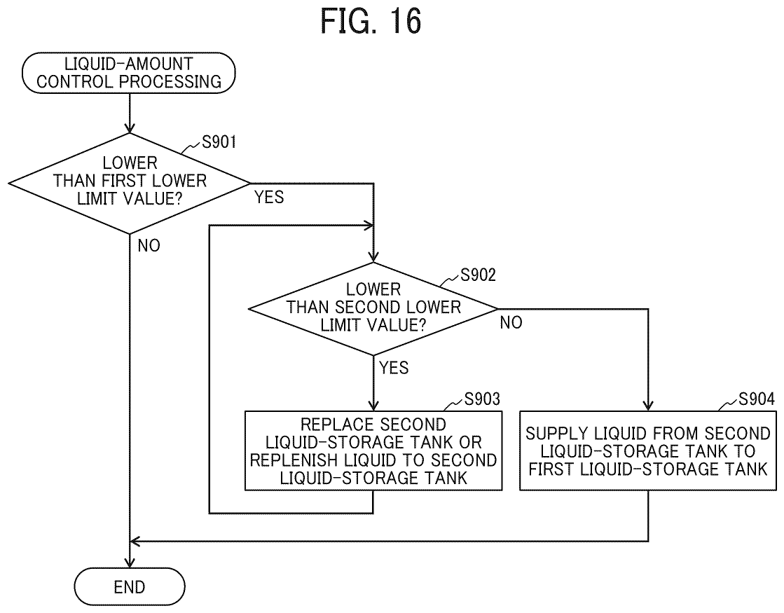

Now, a description is given of a liquid-amount control process. FIG. 16 is a flowchart of the liquid amount control processing. In the liquid-amount control process, the amount of liquid that is stored in the first liquid-storage tank 43 is controlled. The controller 100 executes the liquid-amount control process illustrated in FIG. 16 at a desired time, for example, at the time of initial processing when the power of the post-processing apparatus 3 is turned on or at the time of starting the binding process described below.

First, in step S901, controller 100 determines whether the amount of liquid in the first liquid-storage tank 43 detected by the first liquid-amount sensor 43a has fallen below a first lower limit value. The first lower limit value is set to, for example, a value corresponding to the maximum amount of liquid to be applied in one binding process. When the controller 100 determines that the amount of liquid in the first liquid-storage tank 43 is equal to or greater than the first lower limit value (NO in step S901), the controller 100 ends the liquid-amount control process without executing the operations in step S902 and the subsequent steps.

By contrast, when controller 100 determines that the amount of liquid in the first liquid-storage tank 43 has fallen below the first lower limit value (YES in step S901), in step S902, the controller 100 determines whether the amount of liquid in the second-liquid-storage-tank fixer 52 detected by the second liquid-amount sensor 52a has fallen below a second lower limit value. The second lower limit value is set to, for example, a value corresponding to the amount of liquid supplied to the first liquid-storage tank 43 in step S904 described later.

When the controller 100 determines that the amount of liquid in the second-liquid-storage-tank fixer 52 has fallen below the second lower limit value (YES in step S902), in step S903, the controller 100 provides information through the control panel 110 that the second liquid-storage tank 53 attached to the second-liquid-storage-tank fixer 52 needs to be replaced or the second liquid-storage tank 53 needs to be replenished with liquid if the second liquid-storage tank 53 is not detachable. The way of providing the information in step S903 is not limited to any particular way. For example, a message may be displayed on a display, or an LED lamp may be lit (blinked) as an alternative to the display. The controller 100 continues to provide the information in step S903 until the second liquid-storage tank 53 is replaced and the amount of liquid in the second-liquid-storage-tank fixer 52 becomes equal to or greater than the second lower limit value.

By contrast, when the controller 100 determines that the amount of liquid in the second-liquid-storage-tank fixer 52 is equal to or greater than the second lower limit value (NO in step S902), in step S904, the controller 100 drives the liquid supply pump 55 to supply a predetermined amount of liquid from the second-liquid-storage-tank fixer 52 to the first liquid-storage tank 43. The amount of liquid that is supplied to the first liquid-storage tank 43 in step S904 is set so that the amount of liquid in the first liquid-storage tank 43 does not exceed the first upper limit value.

According to the above-described embodiment, for example, the following operational effects can be obtained.

According to the above-described embodiment, liquid is supplied from the first liquid-storage tank 43 to the liquid application member 44 by capillary action of the first liquid supply portion 45. Thus, since it is not necessary to mount, for example, a liquid supply pump on the liquid applier 31, the liquid applier 31 can be downsized and simplified. In addition, the lower end of the liquid application member 44 is always located higher than the uppermost end of the liquid level in the first liquid-storage tank 43. Such a configuration can prevent liquid from being supplied to the liquid application member 44 in an amount greater than necessary and from dripping from the liquid application member 44. Thus, the amount of liquid applied to the sheet P can be stabilized.

Furthermore, according to the above-described embodiment, the first liquid-storage tank 43 is moved in conjunction with the movement of the liquid application member 44. Thus, the position of the lower end of the liquid application member 44 can be maintained constantly higher than the uppermost end position of the liquid level in the first liquid-storage tank 43. Accordingly, the amount of liquid that is applied to the sheet P increases. Alternatively, the first liquid-storage tank 43 may be fixed to the frame of the liquid applier 31 as long as the relationship between the position of the lower end of the liquid application member 44 and the uppermost end position of the liquid level in the first liquid-storage tank 43 is maintained.

According to the embodiment described above, the liquid is supplied to the first liquid-storage tank 43 from the second-liquid-storage-tank fixer 52, which is fixed outside the movement range of the liquid applier 31. Thus, the capacity of the first liquid-storage tank 43 is reduced. Such a reduced capacity of the first liquid-storage tank 43 can further downsizes the liquid applier 31 and reduces the output of the edge-binder moving motor 50 that moves the liquid applier 31.

Furthermore, according to the above-described embodiment, the second supply speed of the liquid from the second-liquid-storage-tank fixer 52 to the first liquid-storage tank 43 is set o be higher than the first supply speed of the liquid from the first liquid-storage tank 43 to the liquid application member 44. As a result, the liquid can be supplied at high speed and stably to the first liquid-storage tank 43. Thus, the second liquid supply portion 54 can be made longer, which increases the degree of freedom in the position at which the second-liquid-storage-tank fixer 52 is installed. The method of making the second supply speed higher than the first supply speed is not limited to liquid feeding by the liquid supply pump 55 and, for example, gravity may be used.

Furthermore, according to the above-described embodiment, liquid is supplied to the second-liquid-storage-tank fixer 52 from the detachable second liquid-storage tank 53. Thus, the operation of supplying liquid to the liquid applier 31 can be easier than the operation of supplying liquid directly to the first liquid-storage tank 43. In addition, as described above, when the second liquid supply portion 54 is extended and the second-liquid-storage-tank fixer 52 is disposed at a position at which the second liquid-storage tank 53 is easily replaced, the operation of supplying liquid is further facilitated.

Furthermore, according to the above-described embodiment, liquid is supplied to the first liquid-storage tank 43 or the replacement of the second liquid-storage tank 53 is notified, based on the results of detection by the first liquid-amount sensor 43a and the second liquid-amount sensor 52a. Such a configuration can prevent the supply of excessive liquid to the first liquid-storage tank 43 and the shortage of liquid to be applied to the sheet P.

A description is given below of an evaporation preventing mechanism of the liquid application member 44.

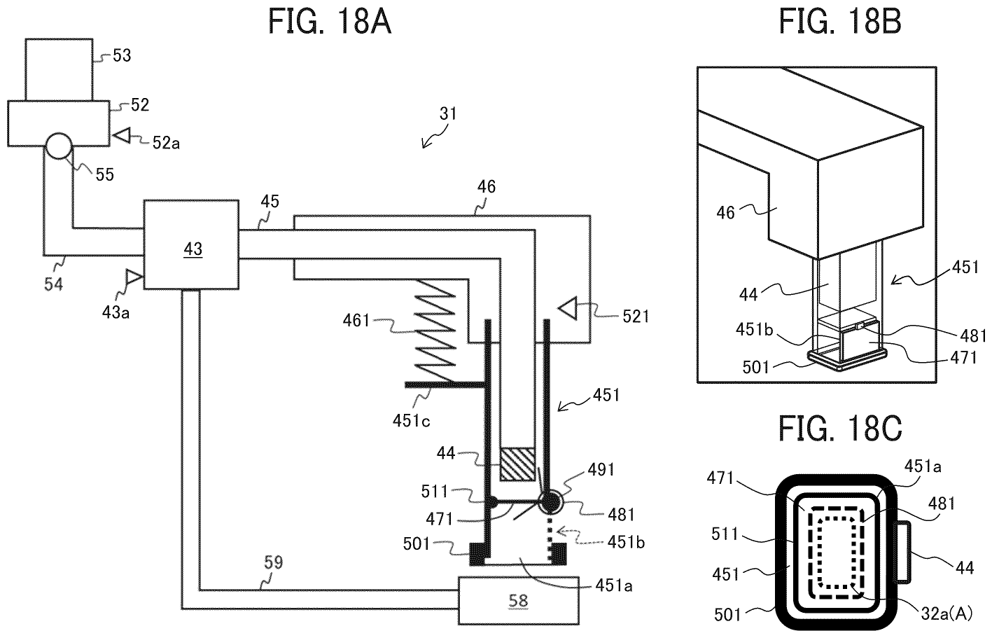

A mechanism for preventing evaporation of liquid contained in the liquid application member 44 in the liquid applier 31 is described with reference to FIGS. 18A to 18C, 19A to 19C, 20A to 20C, and 21A to 21C. Since the liquid application member 44 according to the above-described embodiment is constantly exposed to the outside air, the liquid evaporates from the liquid application member 44 and the amount of liquid applied to the sheet P decreases. As a result, a predetermined amount of liquid is not applied depending on, for example, the type of sheet P, and the binding strength of the sheet bundle Pb may decrease.

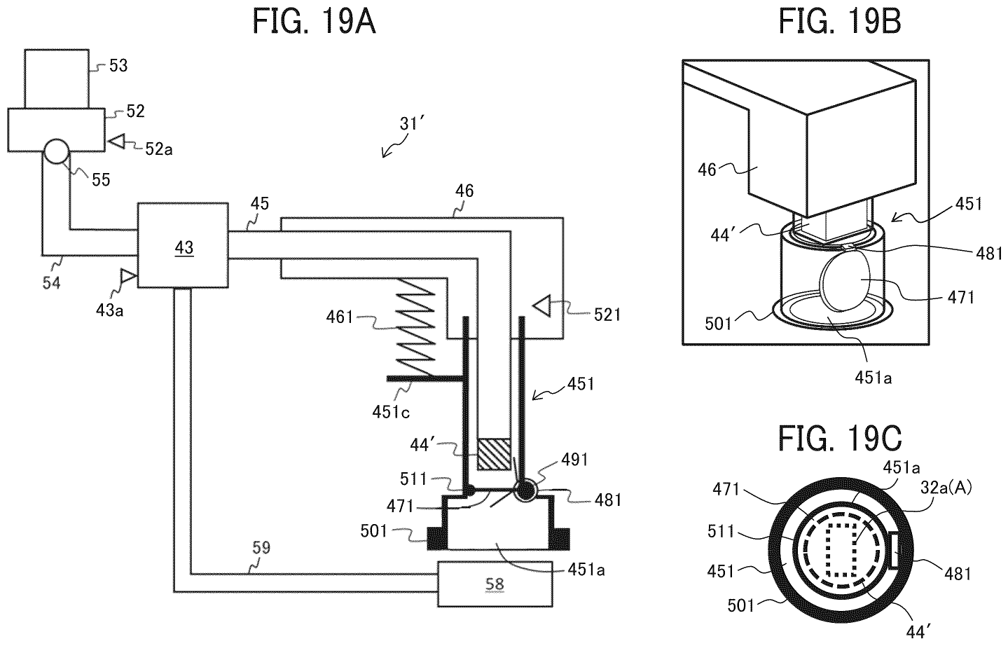

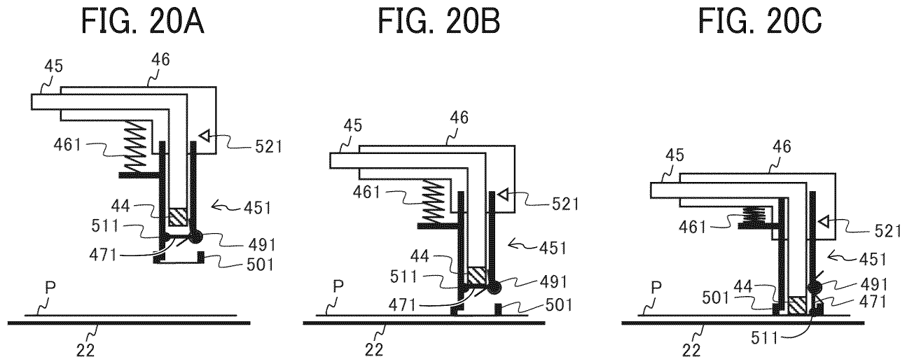

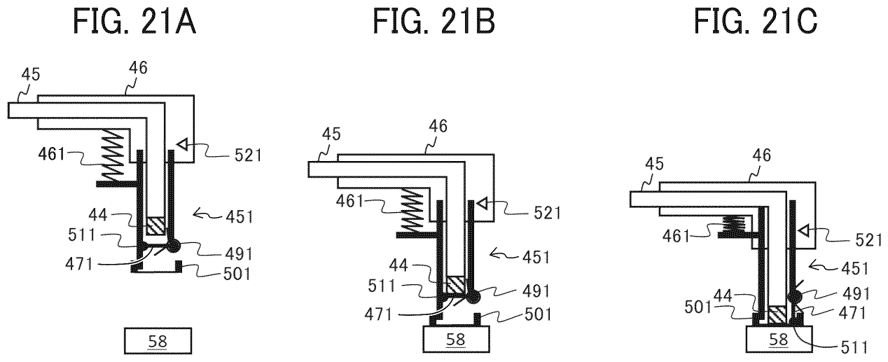

FIG. 18A is a cross-sectional view of the liquid applier 31. FIG. 18B is a perspective view of the liquid applier 31. FIG. 18C is a bottom view of the liquid application member 44. FIG. 19A is a cross-sectional view of a liquid applier 31′ of another embodiment. FIG. 19B is a perspective view of the liquid applier 31′. FIG. 19C is a bottom view of the liquid application member 44′. FIGS. 20A, 20B, and 20C are diagrams illustrating a process of contacting the liquid application member 44 with the sheet P. FIGS. 21A, 21B, and 21C are diagrams illustrating a process of contacting and separating the liquid application member 44 with and from the protection cap 58.

As illustrated in FIG. 18A, the liquid applier 31 includes a first liquid-storage tank 43 (serving as a liquid storage), a first liquid supply portion 45, a liquid application member 44, a holder 46 (serving as a holder), a liquid application member cover 451 (serving as a cover), a coil spring 461 (serving as a second urging member), a cap 471, a hinge 481, a torsion coil spring 491 (serving as a first urging member), an O-ring 501 (serving as a first sealer), an O-ring 511 (serving as a second sealer), and a cover sensor 521. In the present embodiment, main constituent parts (e.g., the first liquid-storage tank 43, the liquid application member 44, the first liquid supply portion 45, the holder 46, and the liquid application member cover 451) of the liquid applier 31 are unitized and move as a single unit in the main scanning direction along the guide shaft 49.

The first liquid supply portion 45 is a long portion that supplies the liquid stored in the first liquid-storage tank 43 to the liquid application member 44. One end of the first liquid supply portion 45 is immersed in the liquid stored in the first liquid-storage tank 43. The liquid application member 44 is attached to the other end of the first liquid supply portion 45. The liquid application member 44 is a portion to be brought into contact with a sheet P supported by the internal tray 22 in a state of containing liquid supplied from the first liquid-storage tank 43 through the first liquid supply portion 45.

The first liquid supply portion 45 and the liquid application member 44 are formed of, for example, a porous member. Thus, the liquid stored in the first liquid-storage tank 43 is supplied to the liquid application member 44 by capillary action. In one example, the first liquid supply portion 45 and the liquid application member 44 may be integrated with, for example, a sponge. In another example, the first liquid supply portion 45 and the liquid application member 44 may be separate bodies. In such a case, the liquid application member 44 may be attachable to and detachable (i.e., replaceable) from the other end of the first liquid supply portion 45. Furthermore, the first liquid supply portion 45 may be expanded and contracted along with the movement of the holder 46, and may be accommodated in the holder 46 in a preliminarily bent state.

The holder 46 is movably supported by the frame of the liquid applier 31. The holder 46 holds the first liquid supply portion 45 and the liquid application member 44. The holder 46 also supports the liquid application member cover 451 such that the liquid application member cover 451 is movable in a direction of coming into contact with or separating from the sheet P or the stack of sheets Pb. When the driving force from the liquid-applier moving motor 37 (serving as a holder mover) (see FIG. 8) is transmitted, the holder 46 moves together with the first liquid supply portion 45, the liquid application member 44, and the liquid application member cover 451 in a direction to approach or move away from the sheet P or the bundle of sheets Pb. Furthermore, the holder 46 moves together with the first liquid supply portion 45 and the liquid application member 44 relative to the liquid application member cover 451 between the second state illustrated in FIG. 20B and the third state illustrated in FIG. 20C.

As illustrated in FIGS. 18A to 18C, the liquid application member cover 451 is formed of a rectangular cylindrical member extending in a direction substantially perpendicular to the sheet P. The liquid application member cover 451 has an internal space that accommodates a portion of the first liquid supply portion 45 and the liquid application member 44 having a rectangular cross section. Another part of the first liquid supply portion 45 is housed in the holder 46. An opening 451a is disposed at a lower end of the liquid application member cover 451. A cutout 451b is formed in a part (a part indicated by a broken line in FIG. 18A) of the lower end of the liquid application member cover 451 in a circumferential direction of the lower end. The liquid application member cover 451 is provided with a support portion 451c that supports the lower end of the coil spring 461.

As another configuration of the liquid application member cover 451, a cylindrical-shaped member may be used as illustrated in FIGS. 19A to 19C. A liquid application member cover 451′ is formed of a two-step cylindrical member having a small diameter portion and a large diameter portion and extending in a direction substantially perpendicular to the sheet P illustrated in FIGS. 19A to 19C. The liquid application member cover 451′ has an internal space that accommodates a portion of a first liquid supply portion 45′ and a liquid application member 44′ (see FIG. 19C) having a cylindrical cross section. In such a case, a cap 471′ may be a disk-shaped member or a curved disk-shaped member having a circular projected outline. As illustrated in FIG. 19B, the liquid application member 44′ may also be formed of a member having a rectangular cross section.

The coil spring 461 is disposed between the holder 46 and the liquid application member cover 451. More specifically, an upper end of the coil spring 461 is connected to a lower end of the holder 46, and a lower end of the coil spring 461 is connected to an upper surface of an support portion 451c of the liquid application member cover 451. The coil spring 461 urges the holder 46 and the liquid application member cover 451 in a direction away from each other in a substantially vertical direction with respect to the sheet P. In other words, the coil spring 461 urges the liquid application member cover 451 downward relative to the holder 46 and urges the holder 46 upward relative to the liquid application member cover 451.

The cap 471 is rotatably supported by the liquid application member cover 451 via the hinge 481. More specifically, the cap 471 is attached to the cutout 451b. The cap 471 is rotatable between a closing position illustrated in FIGS. 20A and 20B and a retracted position illustrated in FIG. 20C. The cap 471 is not limited to the rotatable configuration and may be configured to be movable in the main scanning direction that is a radial direction of the liquid application member cover 451. The torsion coil spring 491 urges the cap 471 toward the closing position.

As illustrated in FIGS. 20A and 20B, the closing position is a position at which the cap 471 closes between the liquid application member 44 and the opening 451a. For example, when the cap 471 is located at the closing position, the liquid application member 44 is housed in the liquid application member cover 451 above the cap 471. In other words, when the cap 471 is located at the closing position, the liquid application member 44 is shielded from the outside air inside the liquid application member cover 451.

As illustrated in FIG. 20C, the retracted position is a position at which the cap 471 is retracted from between the liquid application member 44 and the opening 451a. Foe example, when the cap 471 is located at the retracted position, the liquid application member 44 can descend inside the liquid application member cover 451 to reach a position of the opening 451a. The cap 471 according to the present embodiment closes the cutout 451b when the cap 471 is located at the retracted position. In other words, when the cap 471 is located at the retracted position, the cap 471 forms part of a cut-out wall of the liquid application member cover 451.

The O-ring 501 is made of an elastically-deformable material (e.g., rubber). The O-ring 501 is attached to the lower end of the liquid application member cover 451 to surround the opening 451a. As illustrated in FIGS. 20B and 20C, when the lower end of the liquid application member cover 451 contacts a sheet P, the O-ring 501 comes into close contact with the sheet P so as to surround the opening 451a to prevent the outside air from flowing into the inside of the liquid application member cover 451 through the opening 451a. As illustrated in FIGS. 21B and 21C, when the lower end of the liquid application member cover 451 contacts the protection cap 58, the O-ring 501 comes into intimate contact with the protection cap 58 so as to surround the opening 451a, thereby preventing the outside air from flowing into the inside of the liquid application member cover 451 through the opening 451a.

The O-ring 511 is made of an elastically-deformable material (e.g., rubber). The O-ring 511 is attached to the cap 471 so as to surround the outer peripheral surface of the cap 471. When the cap 471 is located at the closing position, the O-ring 511 comes into close contact with the inner peripheral surface of the liquid application member cover 451. Thus, the outside air is prevented from flowing into the space of the liquid application member cover 451 that houses the liquid application member 44. The O-ring 511 does not need to surround the entire outer peripheral surface of the cap 471. For example, in the case where the liquid application member 44 is made of a material that is less likely to evaporate liquid, there is no problem even if a part of the outer peripheral surface of the cap 471 does not include the O-ring 511.

The cover sensor 521 detects a relative position of the liquid application member cover 451 with respect to the holder 46. More specifically, the cover sensor 521 detects the position of the upper end of the liquid application member cover 451. In other words, the cover sensor 521 detects that the liquid applier 31 has turned into the second state (see FIG. 20B) or the third state (see FIG. 20C). The cover sensor 521 outputs a detection signal indicating a result of detection to the controller 100 (see FIG. 8).

The liquid applier 31 is connected to the second-liquid-storage-tank fixer 52 via a second liquid supply portion 54. The second-liquid-storage-tank fixer 52 is attached to the main-body side plate 72 of the post-processing apparatus 3 independently of the edge binder 25 (liquid applier 31). The second liquid-storage tank 53 (liquid bottle) is removably attached to the second-liquid-storage-tank fixer 52. The second-liquid-storage-tank fixer 52 stores the liquid supplied from the second liquid-storage tank 53. The liquid stored in the second-liquid-storage-tank fixer 52 is supplied to the first liquid-storage tank 43 through the second liquid supply portion 54 by the liquid supply pump 57. The configuration for supplying liquid to the first liquid-storage tank 43 is not limited to the example described above.

The first liquid-storage tank 43 is provided with the first liquid-amount sensor 43a. The second-liquid-storage-tank fixer 52 is provided with the second liquid-amount sensor 52a. The first liquid-amount sensor 43a and the second liquid-amount sensor 52a detect the amounts (remaining amounts) of the liquid stored in the first liquid-storage tank 43 and the second-liquid-storage-tank fixer 52, respectively, and output detection signals indicating the results of detection to the controller 100. When the remaining amount detected by the first liquid-amount sensor 43a is less than a first threshold value, the controller 100 drives the liquid supply pump 57 to supply liquid from the second-liquid-storage-tank fixer 52 to the first liquid-storage tank 43. When the remaining amount detected by the second liquid-amount sensor 52a is less than a second threshold value, the controller 100 provides a notification to replace the second liquid-storage tank 53 through the control panel 110 (see FIG. 8).

The liquid applier 31 includes the protection cap 58 and a reflux path 59. As illustrated in FIG. 3, the protection cap 58 is fixed at a position facing the liquid application member cover 451 in a substantially vertical direction with respect to the sheet P when the liquid applier 31 is at the standby position HP. As illustrated in FIG. 21C, when the liquid applier 31 is at the standby position HP and in the third state, the protection cap 58 comes into close contact with the liquid application member 44 and collects the liquid ejected from the liquid application member 44. The reflux path 59 connects the protection cap 58 and the first liquid-storage tank 43. The reflux path 59 refluxes the liquid collected by the protection cap 58 to the first liquid-storage tank 43. The protection cap 58 and the reflux path 59 are an example of a reflux mechanism.

The state of the liquid applier 31 at the liquid application position B1 changes to the first state illustrated in FIG. 20A, the second state illustrated in FIG. 20B, and the third state illustrated in FIG. 20C according to the control of the controller 100. As the liquid-applier moving motor 37 rotates, the state of the liquid applier 31 according to the present embodiment changes among the first state, the second state, and the third state. More specifically, when the liquid-applier moving motor 37 rotates in a first direction to lower the holder 46, the liquid applier 31 changes from the first state to the third state via the second state. Alternatively, when the liquid-applier moving motor 37 rotates in a second direction to raise the holder 46, the liquid applier 31 changes from the third state to the first state via the second state.

As illustrated in FIG. 20A, the first state is a state of the liquid applier 31 in which the lower end of the liquid application member cover 451 is located above the sheet P supported by the internal tray 22 and the cap 471 is at the closing position. In other words, when the liquid applier 31 is in the first state, the sheet P conveyed in the conveyance direction by the conveyance roller pair 15 is allowed to enter the internal tray 22. When the liquid applier 31 is in the first state, the liquid application member 44 is housed inside the liquid application member cover 451 closed by the cap 471 at the closing position and is shielded from the outside air.

As illustrated in FIG. 20B, the second state is a state of the liquid applier 31 in which the lower end of the liquid application member cover 451 (more specifically, the O-ring 501) is in contact with the sheet P supported by the internal tray 22 and the cap 471 is at the closing position. Thus, the sheet P supported by the internal tray 22 is fixed by the liquid application member cover 451. On the other hand, the liquid application member 44 is still isolated from the outside air inside the liquid application member cover 451.

As illustrated in FIG. 20C, the third state is a state of the liquid applier 31 in which the lower end of the liquid application member cover 451 (more specifically, the O-ring 501) is in contact with the sheet P supported by the internal tray 22, the cap 471 is at the retracted position, and the liquid application member 44 is in contact with the sheet P supported by the internal tray 22. Thus, the liquid contained in the liquid application member 44 is applied to the sheet P. The space between the liquid application member cover 451 and the sheet P is sealed by the O-ring 501 and the cutout 451b is closed by the cap 471 located at the retracted position. Thus, the amount of the outside air entering the inside of the liquid application member cover 451 is reduced.

In the case where the liquid-applier moving motor 37 is rotated in the first direction when the liquid applier 31 is in the first state, the liquid application member 44, the holder 46, the liquid application member cover 451, the coil spring 461, the cap 471, the hinge 481, the torsion coil spring 491, the O-rings 501 and 511, and the cover sensor 521 move downward together. The relative positions of the liquid application member 44, the first liquid supply portion 45, the holder 46, and the liquid application member cover 451 do not change until the lower end of the liquid application member cover 451 contacts the sheet P.

When the liquid-applier moving motor 37 further rotates in the first direction after the lower end (the O-ring 501) of the liquid application member cover 451 contacts the sheet P, the liquid application member 44, the holder 46, and the cover sensor 521 move downward against the urging force of the coil spring 461 (i.e., while elastically compressing the coil spring 461). Thus, the liquid application member 44 approaches the cap 471 and the upper end of the liquid application member cover 451 approaches the detection position of the cover sensor 521.

When the liquid-applier moving motor 37 is further rotated in the first direction after the liquid applier 31 turns into the second state, the liquid application member 44, the holder 46, and the cover sensor 521 further move downward against the urging force of the coil spring 461. The liquid application member 44 moving downward inside the liquid application member cover 451 comes into contact with the cap 471 located at the closing position and rotates (moves) the cap 471 from the closing position to the retracted position against the urging force of the torsion coil spring 491. As the liquid application member 44 further descends to the position of the opening 451a, the liquid applier 31 turns into the second state.

The amount of lowering from the first state to the second state changes according to the thickness and the number of sheets P supported by the internal tray 22. For this reason, the controller 100 may determine that the liquid applier 31 has turned into the second state, when the upper end of the liquid application member cover 451 is detected by the cover sensor 521. On the other hand, the amount of lowering from the second state to the third state is constant. Thus, the controller 100 need only determine that the liquid applier 31 has turned into the third state, based on a pulse signal output from the rotary encoder of the liquid-applier moving motor 37.

In the case where the liquid-applier moving motor 37 is rotated in the second direction when the liquid applier 31 is in the third state, the liquid application member 44, the holder 46, and the cover sensor 521 move upward. When the liquid application member 44 moves upward to above the cap 471 (the cutout 451b), the liquid application member 44 separates from the cap 471. Thus, the cap 471 moves from the retracted position to the closing position by the urging force of the torsion coil spring 491. On the other hand, the lower end of the liquid application member cover 451 is still in contact with the sheet P. In response to the upper end of the liquid application member cover 451 not being detected by the cover sensor 521, the controller 100 may determine that the liquid applier 31 has turned into the second state.

When the liquid-applier moving motor 37 is further rotated in the second direction after the liquid applier 31 is turned into the second state, the coil spring 461 expands completely, and the liquid application member 44, the holder 46, the liquid application member cover 451, the coil spring 461, the cap 471, the hinge 481, the torsion coil spring 491, the O-rings 501 and 511, and the cover sensor 521 move upward together. Thus, the lower end of the liquid application member cover 451 is separated from the sheet P. The controller 100 may determine that the liquid applier 31 has turned into the first state, based on a pulse signal output from the rotary encoder of the liquid-applier moving motor 37.

The liquid applier 31 is also changeable at the standby position HP among the first state illustrated in FIG. 21A, the second state illustrated in FIG. 21B, and the third state illustrated in FIG. 21C. The process in which the liquid applier 31 changes is the same as described with reference to FIGS. 20A, 20B, and 20C. When the liquid applier 31 at the standby position HP turns into the third state, the liquid application member 44 comes into close contact with the protection cap 58. As a result, during standby of the liquid applier 31, the liquid application member 44 is prevented from being exposed to the outside air, and the liquid ejected from the liquid application member 44 is refluxed to the first liquid-storage tank 43 through the protection cap 58 and the reflux path 59.

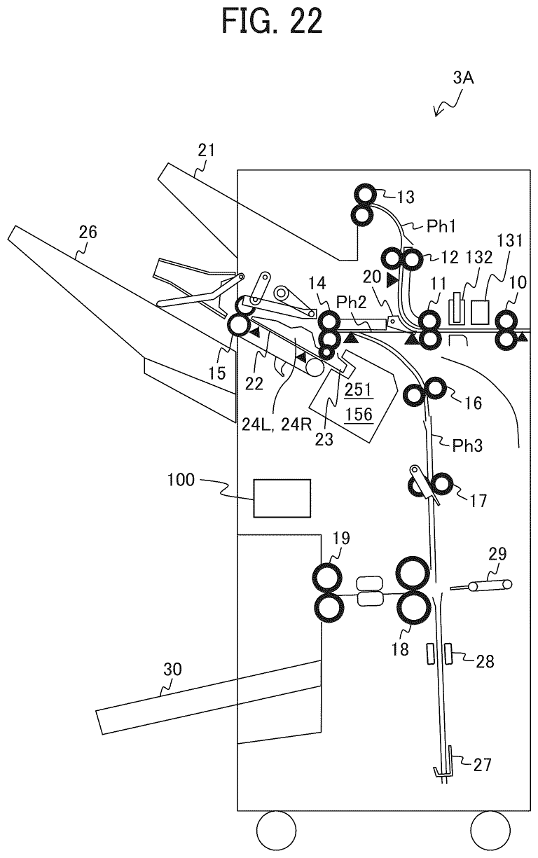

A post-processing apparatus 3A according to a second embodiment is described with reference to FIGS. 22 to 30. In the following description, the same components as those of the first embodiment are denoted by the same reference numerals, and the description thereof may be omitted.

The post-processing apparatus 3A according to the second embodiment includes an edge binder 251. The edge binder 251 is different from the edge binder 25 of the post-processing apparatus 3 according to the first embodiment, in which the liquid applier 31 and the crimper 32 are arranged side by side, in that the edge binder 251 includes a crimper 32′ and a liquid applier 131 is disposed at an upstream position in a direction in which a sheet P is conveyed. Such a configuration allows a given number of sheets P to be stacked after the liquid application process and conveyed to the crimper 32′ of the edge binder 251 disposed at a downstream position in the direction in which the sheet P is conveyed. Accordingly, the productivity of the binding process performed by the crimper 32′ is enhanced.

Since the direction in which the conveyance roller pairs 10, 11, and 14 convey the sheet P is opposite to the “conveyance direction” defined above, the direction in which the conveyance roller pairs 10, 11, and 14 convey the sheet P is defined as an “opposite conveyance direction” in the following description. A direction that is orthogonal to the opposite conveyance direction and the thickness direction of the sheet P is defined as the “main scanning direction” or the “width direction of the sheet P.” The liquid application position to which the liquid is applied on the sheet P or the sheet bundle Pb by the liquid applier 131 corresponds to the binding position on the sheet bundle Pb to be crimped and bound by the crimper 32′. For this reason, in the following description, the liquid application position and the binding position are denoted by the same reference numeral.

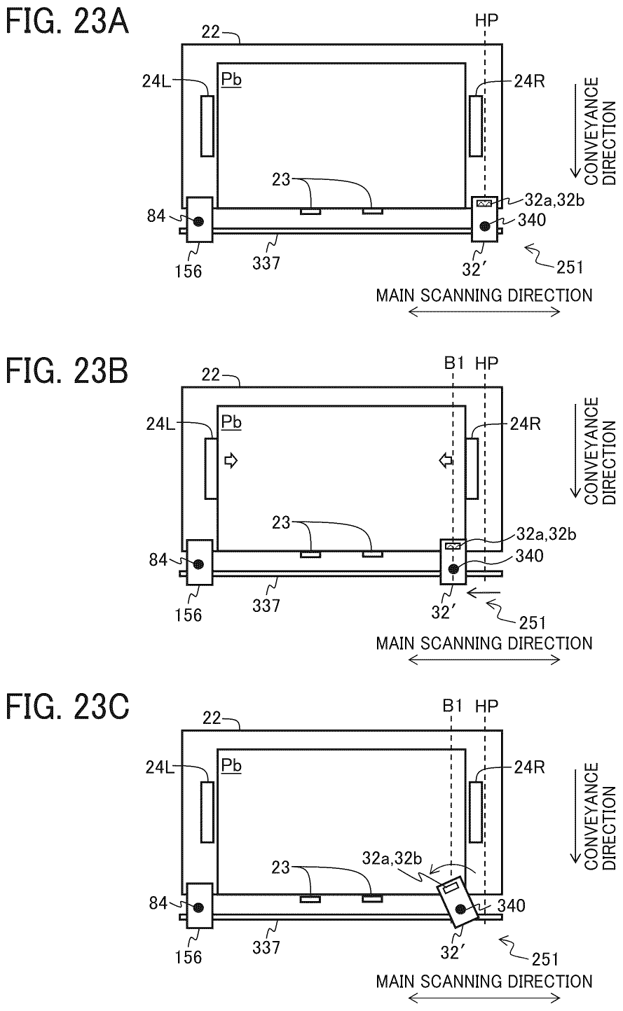

FIG. 22 is a diagram illustrating an internal configuration of the post-processing apparatus 3A according to the second embodiment of the present disclosure. As illustrated in FIGS. 23A, 23B, and 23C, the edge binder 251 includes only the crimper 32′. As illustrated in FIG. 22, the crimper 32′ and a stapling unit 156 are disposed downstream from the internal tray 22 in the conveyance direction. In addition, the crimper 32′ and the stapling unit 156 are located to face a downstream end, in the conveyance direction, of the sheet bundle Pb placed on the internal tray 22 and is movable in the main scanning direction. Further, the crimper 32′ and the stapling unit 156 are respectively rotatable in the forward and reverse directions about a crimper shaft 340 and a stapler shaft 84 both extending in the thickness direction of the sheet bundle Pb placed on the internal tray 22. In other words, the crimper 32′ and the stapling unit 156 bind, at a desired angle, a desired position in the main scanning direction on the sheet bundle Pb placed on the internal tray 22 in, for example, corner oblique binding, parallel one-point binding, or parallel two-point binding.

The crimper 32′ presses and deforms the sheet bundle Pb with the serrate upper crimping teeth 32b and the serrate lower crimping teeth 32b to bind the sheet bundle Pb. In the following description, such a binding way may be referred to as “crimp binding.” In other words, the crimper 32′ crimps and binds the sheet bundle Pb or performs the crimp binding on the sheet bundle Pb. On the other hand, the stapling unit 156 passes the staple through a binding position on the sheet bundle Pb placed on the internal tray 22 to staple the sheet bundle Pb.

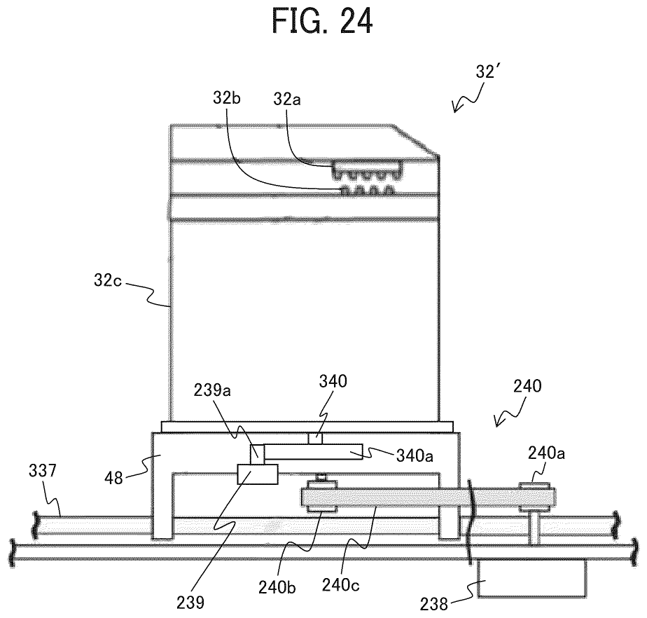

Each of FIGS. 23A, 23B, and 23C is a schematic view of the internal tray 22 in the thickness direction of the sheet bundle Pb. FIG. 24 is a schematic view of a downstream side of the crimper 32′ in the conveyance direction. As illustrated in FIGS. 23A, 23B, and 23C, the crimper 32′ and the stapling unit 156 are disposed downstream from the internal tray 22 in the conveyance direction. The crimper 32′ is movable in the main scanning direction along the surface of the sheet bundle Pb placed on the internal tray 22. The crimper 32′ is also rotatable in the forward and reverse directions about the crimper shaft 340 extending in the thickness direction of the sheet bundle Pb placed on the internal tray 22. Similarly, the stapling unit 156 is movable in the main scanning direction of the sheet bundle Pb and is rotatable in the forward and reverse directions about the stapler shaft 84 extending in the thickness direction of the sheet bundle Pb. Since the other configurations of the stapling unit 156 are like those of the stapling unit 155 (illustrated in FIG. 6) of the post-processing apparatus 3 according to the first embodiment, a detailed description thereof will be omitted unless otherwise required.

As illustrated in FIG. 24, the crimper 32′ includes a guide rail 337 extending in the main scanning direction at a position downstream from the internal tray 22 in the conveyance direction. The crimper 32′ is moved in the main scanning direction along the surface of the sheet bundle Pb placed on the internal tray 22, in other words, along the guide rail 337, by a driving force that is transmitted from a crimper moving motor 238 by a drive transmission assembly 240 including pullies 240a and 240b and a timing belt 240c. A crimper shaft 340 including a drive transmission gear 340a is fixed to a bottom face of the crimping frame 32c that holds the components of the crimper 32. The crimper shaft 340 and the drive transmission gear 340a are held by the base 48 on which the crimping frame 32c is disposed, so as to be rotatable in the forward and reverse directions. The drive transmission gear 340a meshes with an output gear 239a of a crimper pivot motor 239. The crimper 32′ is rotated in the forward and reverse directions on the base 48 about the crimper shaft 340 extending in the thickness direction of the sheet P placed on the internal tray 22, by a driving force transmitted from the crimper pivot motor 239 to the crimper shaft 340 via the output gear 239a and the drive transmission gear 340a. The guide rail 337, the crimper moving motor 238, the crimper pivot motor 239, the crimper shaft 340, and the drive transmission assembly 240 constitute at least part of a driving assembly of the crimper 32′ according to the second embodiment.

The crimper 32′ moves between the standby position HP illustrated in FIG. 23A and a position where the crimper 32′ faces the binding position B1 illustrated in FIGS. 23B and 23C. The standby position HP is away in the main scanning direction from the sheet bundle Pb placed on the internal tray 22. For example, in FIGS. 23A, 23B, and 23C, the standby position HP is away from the right side of the sheet bundle Pb in the main scanning direction. The binding position B1 is a position on the sheet bundle Pb placed on the internal tray 22. However, the specific position of the binding position B1 is not limited to the position illustrated in FIGS. 23B and 23C. The binding position B1 may be one or more positions along the main scanning direction at the downstream end, in the conveyance direction, of the sheet P.

The posture of the crimper 32′ changes between a parallel binding posture illustrated in FIG. 23B and an oblique binding posture illustrated in FIG. 23C. In other words, the crimper 32′ is rotatable in the forward and reverse directions about the crimper shaft 340. The parallel binding posture is a posture of the crimper 32′ in which the length of the upper crimping teeth 32a and the lower crimping teeth 32b (in other words, a rectangular crimp binding trace) is along the main scanning direction. The oblique binding posture is a posture of the crimper 32′ in which the length of the upper crimping teeth 32a and the lower crimping teeth 32b (in other words, the rectangular crimp binding trace) is inclined with respect to the main scanning direction.

The rotational angle, which is an angle of the upper crimping teeth 32a and the lower crimping teeth 32b with respect to the main scanning direction, in the oblique binding posture is not limited to the angle illustrated in FIG. 23C. The rotational angle in the oblique binding posture may be any angle provided that the upper crimping teeth 32a and the lower crimping teeth 32b face the sheet bundle Pb placed on the internal tray 22.

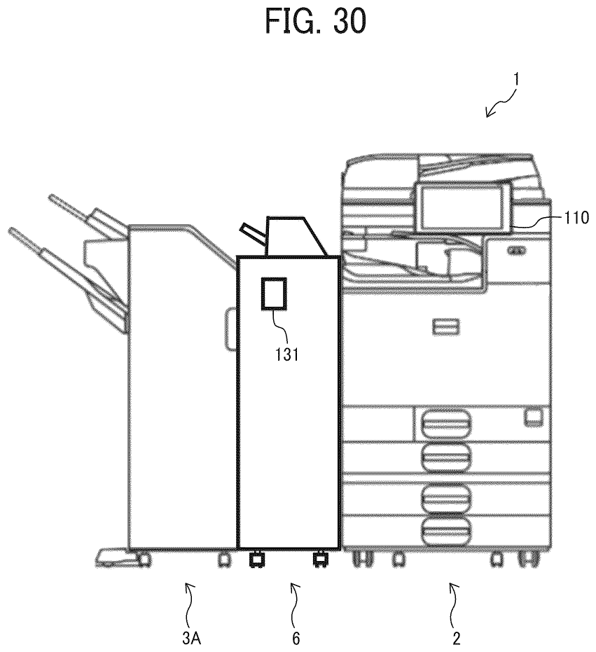

The post-processing apparatus 3A includes the liquid applier 131 and a hole punch 132 serving as a processor. The liquid applier 131 and the hole punch 132 are disposed upstream from the internal tray 22 in the opposite conveyance direction. In addition, the liquid applier 131 and the hole punch 132 are disposed at different positions in the opposite conveyance direction to simultaneously face one sheet P that is conveyed by the conveyance roller pairs 10 to 19. The liquid applier 131 and the hole punch 132 according to the present embodiment are disposed between the conveyance roller pairs 10 and 11. However, the arrangement of the liquid applier 131 and the hole punch 132 is not limited to the embodiment illustrated in FIG. 22. For example, in a case where an inserter 6 is disposed between the image forming apparatus 2 and the post-processing apparatus 3A as illustrated in FIG. 30, the liquid applier 131 may be disposed inside the inserter 6 located upstream from the post-processing apparatus 3A in a direction in which the sheet P is conveyed from the image forming apparatus 2 to the post-processing apparatus 3A. Examples of the inserter 6 include, but are not limited to, an apparatus that allows a pre-printed medium, which is to be conveyed to the post-processing apparatus 3A together with the sheet P conveyed from the image forming apparatus 2, to be fed as a cover sheet, an insertion sheet, or a partition sheet without passing through the image forming apparatus 2.

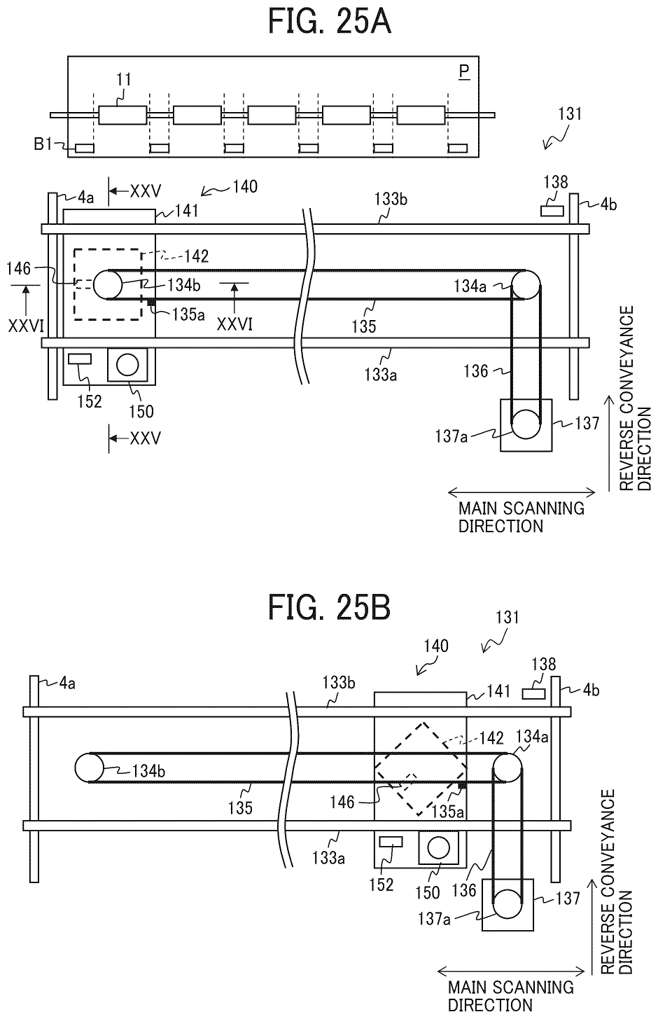

As illustrated in FIG. 25A, the conveyance roller pair 11 is located so as not to overlap, in the main scanning direction, the liquid application position B1 on the sheet P to which the liquid has been applied by a liquid application head 146 of the liquid applier 131. This is to prevent the amount of liquid at the liquid application position B1 from decreasing due to the plurality of roller pairs pressing the liquid application position B1 when the conveyance roller pair 11 conveys the sheet P. As a result, when the sheet P reaches the crimper 32′ disposed downstream from the liquid applier 131 in the opposite conveyance direction, the amount of liquid at the liquid application position B1 is sufficient to maintain the binding strength. Accordingly, the binding strength of the sheet bundle Pb is prevented from decreasing due to a decrease in the amount of liquid at the liquid application position B1 while the sheet P is conveyed.

In addition, the plurality of roller pairs of the conveyance roller pair 11 that is located so as not to overlap the liquid application position B1 on the sheet P in the main scanning direction prevents the conveying performance of the sheet P from being worse due to the adhesion of liquid to the plurality of roller pairs and further prevents a conveyance jam caused by the worsened conveying performance of the sheet P.

Although only the conveyance roller pair 11 has been described above, the plurality of roller pairs of the conveyance roller pairs 14 and 15 are preferably located so as not to overlap the liquid application position B1 on the sheet P in the main scanning direction, like the plurality of roller pairs of the conveyance roller pair 11.

The liquid applier 131 applies liquid (for example, water) to the sheet P that is conveyed by the conveyance roller pairs 10 and 11. In the following description, the application of liquid may be referred to as “liquid application.” The hole punch 132 punches a hole in the sheet P that is conveyed by the conveyance roller pairs 10 and 11 such that the hole penetrates the sheet P in the thickness direction of the sheet P. The processor disposed near the liquid applier 131 is not limited to the hole punch 132. Alternatively, the processor may be an inclination corrector that corrects an inclination or skew of the sheet P that is conveyed by the conveyance roller pairs 10 and 11.

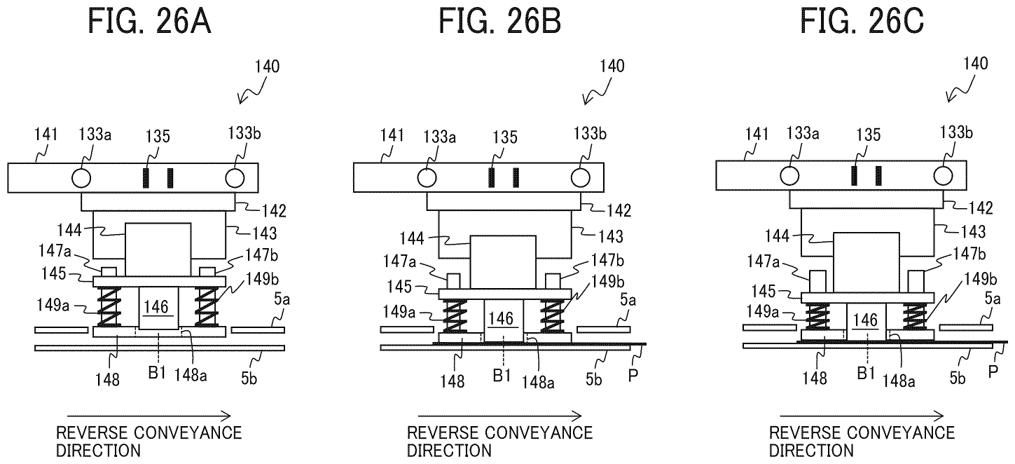

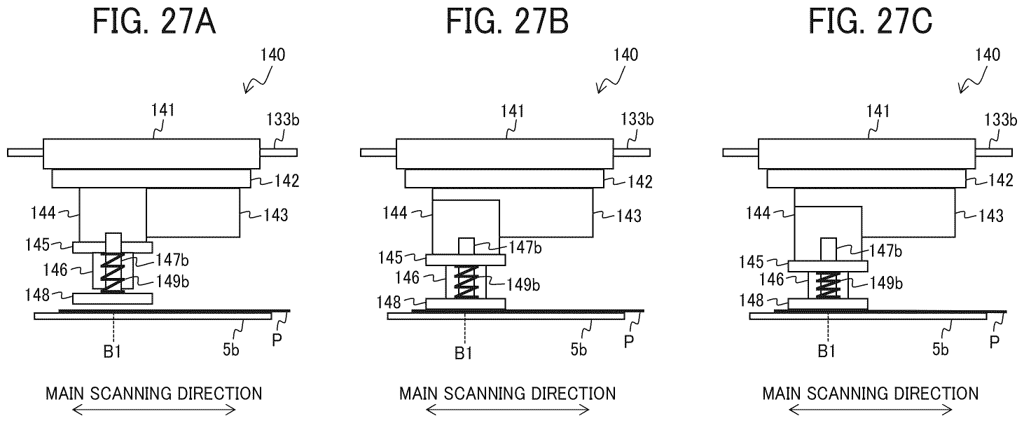

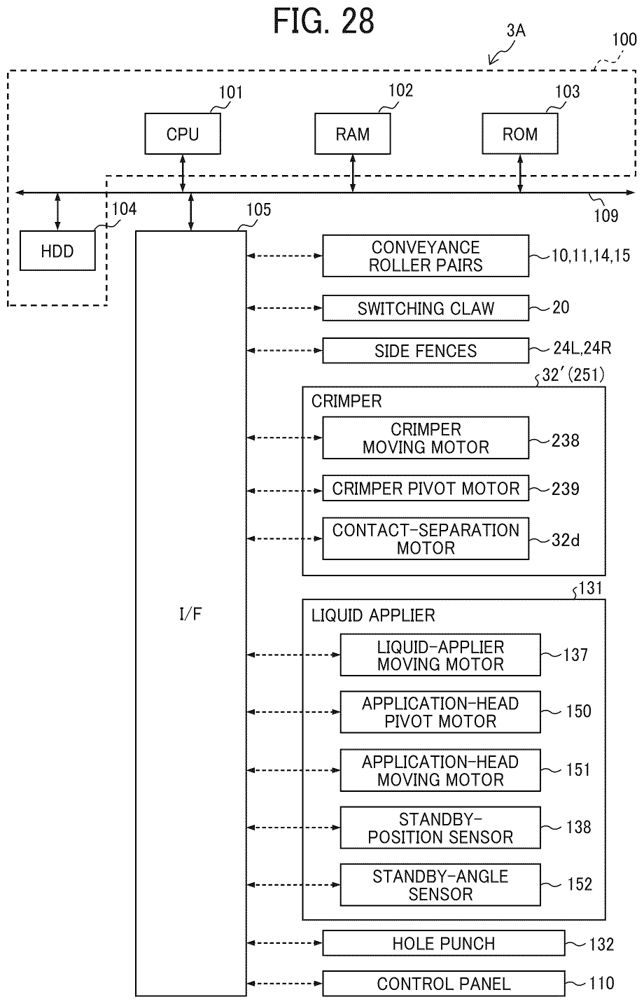

FIGS. 25A and 25B are views of the liquid applier 131 in the thickness direction of the sheet P, according to the second embodiment of the present disclosure. FIGS. 26A, 26B, and 26C are cross-sectional views of a liquid application unit 140 of the liquid applier 131 taken through XXV-XXV of FIG. 25A. FIGS. 27A, 27B, and 27C are cross-sectional views of the liquid application unit 140 of the liquid applier 131 taken through XXVI-XXVI of FIG. 25A. As illustrated in FIGS. 25A to 27C, the liquid applier 131 includes a pair of guide shafts 133a and 133b, a pair of pulleys 134a and 134b, endless annular belts 135 and 136, a liquid applier moving motor 137, a standby-position sensor 138 (see FIG. 28), and a liquid application unit 140.

The guide shafts 133a and 133b, each extending in the main scanning direction, are apart from each other in the reverse conveyance direction. The pair of guide shafts 133a and 133b is supported by a pair of side plates 4a and 4b of the post-processing apparatus 3A. On the other hand, the pair of guide shafts 133a and 133b supports the liquid application unit 140 such that the liquid application unit 140 can move in the main scanning direction.

The pair of pulleys 134a and 134b is disposed between the guide shafts 133a and 133b in the reverse conveyance direction. On the other hand, the pulleys 134a and 134b are apart from each other in the main scanning direction. The pulleys 134a and 134b are supported by a frame of the post-processing apparatus 3A so as to be rotatable in the forward and reverse directions about the respective shafts extending in the thickness direction of the sheet P.

The endless annular belt 135 is entrained around the pair of pulleys 134a and 134b. The endless annular belt 135 is coupled to the liquid application unit 140 by a connection 135a. The endless annular belt 136 is entrained around the pulley 134a and a driving pulley 137a that is fixed to an output shaft of the liquid-applier moving motor 137. The liquid-applier moving motor 137 generates a driving force to move the liquid application unit 140 in the main scanning direction.

As the liquid-applier moving motor 137 rotates, the endless annular belt 136 circulates around the pulley 134a and the driving pulley 137a to rotate the pulley 134a. As the pulley 134a rotates, the endless annular belt 135 circulates around the pair of pulleys 134a and 134b. As a result, the liquid application unit 140 moves in the main scanning direction along the pair of guide shafts 133a and 133b. The liquid application unit 140 reciprocates in the main scanning direction in response to switching of the rotation direction of the liquid-applier movement motor 137.

The standby-position sensor 138 detects the arrival of the liquid application unit 140 at a standby position in the main scanning direction. The standby-position sensor 138 then outputs a standby position signal indicating the detection result to the controller 100 as circuitry, which will be described below with reference to FIG. 28. The standby-position sensor 138 is, for example, an optical sensor including a light emitting unit and a light receiving unit. The liquid application unit 140 at the standby position blocks an optical path between the light emitting unit and the light receiver. The standby-position sensor 138 outputs the standby position signal in response to the light output from the light emitter not being received by the light receiver. The specific configuration of the standby-position sensor 138 is not limited to the configuration described above.

As illustrated in FIGS. 26A, 26B, and 26C, the conveyance passage inside the post-processing apparatus 3A is defined by an upper guide plate 5a and a lower guide plate 5b, which are apart from each other in the thickness direction of the sheet P. The liquid application unit 140 is located to face an opening of the upper guide plate 5a. In other words, the liquid application unit 140 faces the conveyance passage through the opening of the upper guide plate 5a to face the sheet P conveyed along the conveyance passage.

As illustrated in FIGS. 25A to 27C, the liquid application unit 140 includes a base 141, a rotary bracket 142, a liquid-storage tank 143, a mover 144, a holder 145, the liquid application head 146, columns 147a and 147b, a pressure plate 148, coil springs 149a and 149b, an application-head pivot motor 150, an application-head moving motor 151 illustrated in FIG. 28, and a standby-angle sensor 152, which is also illustrated in FIG. 28.

The base 141 is supported by the pair of guide shafts 133a and 133b so as to be slidable in the main scanning direction. The base 141 is coupled to the endless annular belt 135 by the connection 135a. On the other hand, the base 141 supports the components of the liquid application unit 140 such as the rotary bracket 142, the liquid-storage tank 143, the mover 144, the holder 145, the liquid application head 146, the columns 147a and 147b, the pressure plate 148, the coil springs 149a and 149b, the application-head pivot motor 150, the application-head moving motor 151, and the standby-angle sensor 152.

The rotary bracket 142 is supported by a lower face of the base 141 so as to be pivotable about an axis extending in the thickness direction of the sheet P. The rotary bracket 142 is rotated with respect to the base 141 by a driving force transmitted from the application-head pivot motor 150. The rotary bracket 142 supports the liquid-storage tank 143, the mover 144, the holder 145, the liquid application head 146, the columns 147a and 147b, the pressure plate 148, and the coil springs 149a and 149b.

The standby-angle sensor 152, which is also illustrated in FIG. 28, detects that the rotary bracket 142 has reached a standby angle. The standby-angle sensor 152 then outputs a standby angle signal indicating the detection result to the controller 100. The standby angle is, for example, an angle for the parallel binding. The standby-angle sensor 152 is, for example, an optical sensor including a light emitter and a light receiver. The rotary bracket 142 at the standby angle blocks an optical path between the light emitter and the light receiver. The standby-angle sensor 152 outputs the standby angle signal in response to the light output from the light emitter not being received by the light receiver. The specific configuration of the standby-angle sensor 152 is not limited to the configuration described above.

FIG. 25A illustrates the rotary bracket 142 in a position for the parallel binding that is performed by the crimper 32′ disposed downstream from the liquid applier 131 in a direction in which the sheet P is conveyed. FIG. 25B illustrates the rotary bracket 142 in a position for the oblique binding (i.e., corner binding) that is performed by the crimper 32′ disposed downstream from the liquid applier 131 in the direction in which the sheet P is conveyed.

The liquid-storage tank 143 stores liquid to be applied to the sheet P. The mover 144 is supported by the liquid-storage tank 143 so as to be movable (for example, up and down) in the thickness direction of the sheet P. The mover 144 is moved with respect to the liquid-storage tank 143 by a driving force transmitted from the application-head moving motor 151. The holder 145 is attached to a lower end of the mover 144. The liquid application head 146 projects from the holder 145 toward the conveyance passage (downward in the present embodiment). The liquid that is stored in the liquid-storage tank 143 is supplied to the liquid application head 146. The liquid application head 146 is made of a material having a relatively high liquid absorption (for example, sponge or fiber).

The columns 147a and 147b project downward from the holder 145 around the liquid application head 146. The columns 147a and 147b can move relative to the holder 145 in the thickness direction. The columns 147a and 147b have respective lower ends holding the pressure plate 148. The pressure plate 148 has a through hole 148a at a position where the through hole 148a faces the liquid application head 146. The coil springs 149a and 149b are fitted around the columns 147a and 147b, respectively, between the holder 145 and the pressure plate 148. The coil springs 149a and 149b bias the columns 147a and 147b and the pressure plate 148 downward with respect to the holder 145.

As illustrated in FIGS. 26A and 27A, before the sheet P is conveyed to the position where the sheet P faces the opening of the upper guide plate 5a, the pressure plate 148 is positioned at or above the opening. Subsequently, when the sheet P that is conveyed by the conveyance roller pairs 10 and 11 stops at a position where the liquid application position B1 on the sheet P faces the opening, the application-head moving motor 151 is rotated in a first direction. As a result, the mover 144, the holder 145, the liquid application head 146, the columns 147a and 147b, the pressure plate 148, and the coil springs 149a and 149b are moved down together to allow the pressure plate 148 to contact the sheet P. The liquid application position B1 corresponds to the binding position B1 to be crimped and bound by the edge binder 251, specifically, the crimper 32′.

As the application-head moving motor 151 keeps rotating in the first direction after the pressure plate 148 contacts the sheet P, the coil springs 149a and 149b are compressed to further move down the mover 144, the holder 145, the liquid application head 146, and the columns 147a and 147b. As a result, as illustrated in FIGS. 26B and 27B, a lower face of the liquid application head 146 contacts the sheet P through the through hole 148a. Then, the liquid contained in the liquid application head 146 is applied to the sheet P.

Further rotation of the application-head moving motor 151 in the first direction further strongly presses the liquid application head 146 against the sheet P as illustrated in FIGS. 26C and 27C. Accordingly, the amount of liquid that is applied to the sheet P increases. In short, the liquid applier 131 changes the pressing force of the liquid application head 146 against the sheet P to adjust the amount of liquid that is applied to the sheet P.

On the other hand, the rotation of the application-head moving motor 151 in a second direction opposite to the first direction moves up the mover 144, the holder 145, the liquid application head 146, the columns 147a and 147b, the pressure plate 148, and the coil springs 149a and 149b together. As a result, as illustrated in FIGS. 26A and 27A, the liquid application head 146 and the pressure plate 148 are separated from the sheet P. In other words, the liquid applier 131 includes the liquid application head 146 that can be separated from the sheet P.

FIG. 28 is a block diagram illustrating a hardware configuration of the post-processing apparatus 3A to control the operation of the post-processing apparatus 3A according to the second embodiment of the present disclosure. As illustrated in FIG. 28, the post-processing apparatus 3A includes the CPU 101, the RAM 102, the ROM 103, the HDD 104, and the I/F 105. The CPU 101, the RAM 102, the ROM 103, the HDD 104, and the I/F 105 are connected to each other via the common bus 109.

The CPU 101 is an arithmetic unit and controls the overall operation of the post-processing apparatus 3A. The RAM 102 is a volatile storage medium that allows data to be read and written at high speed. The CPU 101 uses the RAM 102 as a working area for data processing. The ROM 103 is a read-only non-volatile storage medium that stores programs such as firmware. The HDD 104 is a non-volatile storage medium that allows data to be read and written and has a relatively large storage capacity. The HDD 104 stores, e.g., an operating system (OS), various control programs, and application programs.

By an arithmetic function of the CPU 101, the post-processing apparatus 3A processes, for example, a control program stored in the ROM 103 and an information processing program (application program) loaded into the RAM 102 from a storage medium such as the HDD 104. Such processing configures a software controller including various functional modules of the post-processing apparatus 3A. The software controller thus configured cooperates with hardware resources of the post-processing apparatus 3A to construct functional blocks that implement functions of the post-processing apparatus 3A. In other words, the CPU 101, the RAM 102, the ROM 103, and the HDD 104 construct the controller 100 that controls the operation of the post-processing apparatus 3A.

The I/F 105 is an interface that connects the conveyance roller pairs 10, 11, 14, and 15, the switching claw 20, the side fences 24L and 24R, the crimper moving motor 238, the crimper pivot motor 239, the contact-separation motor 32d, the liquid-applier moving motor 137, the application-head pivot motor 150, the application-head moving motor 151, the standby-position sensor 138, the standby-angle sensor 152, the hole punch 132, and the control panel 110 to the common bus 109. The controller 100 controls, via the I/F 105, the operations of the conveyance roller pairs 10, 11, 14, and 15, the switching claw 20, the side fences 24L and 24R, the crimper moving motor 238, the crimper pivot motor 239, the contact-separation motor 32d, the liquid-applier moving motor 137, the application-head pivot motor 150, the application-head moving motor 151, and the hole punch 132.

The controller 100 acquires detection results from the standby-position sensor 138 and the standby-angle sensor 152 through the I/F 105. Although FIG. 28 illustrates the components of the liquid applier 131 and the edge binder 251 (the crimper 32′) that executes the edge binding, the components of the saddle binder 28 that executes the saddle binding are controlled by the controller 100 like the components of the liquid applier 131 and the edge binder 251 (the crimper 32′) that executes the edge binding.

The control panel 110 includes an operation device that receives instructions input by an operator and a display serving as a notifier that notifies the operator of information. The operation device includes, for example, physical input buttons and a touch screen overlaid on a display. The control panel 110 acquires information from the operator through the operation device and provides information to the operator through the display.

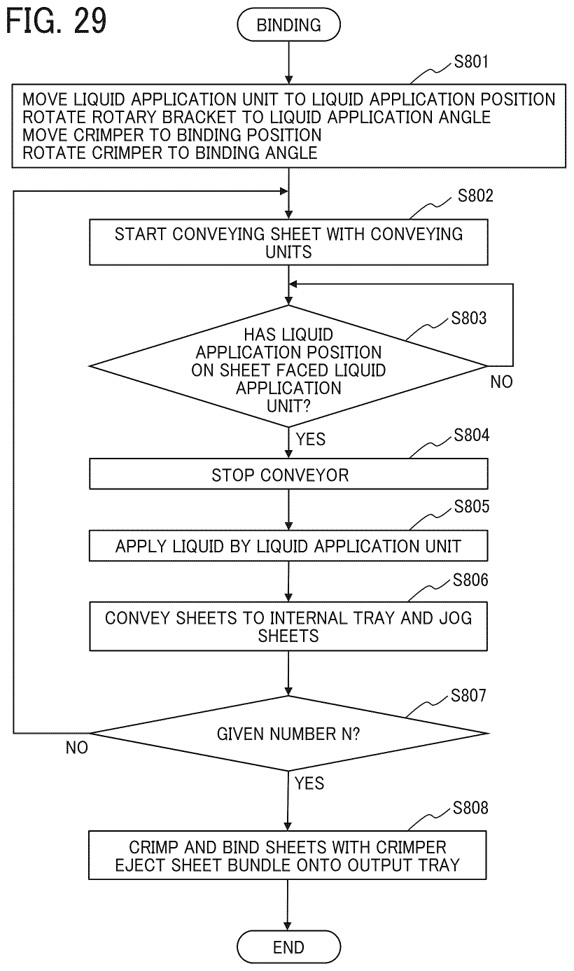

FIG. 29 is a flowchart of post-processing performed by the post-processing apparatus 3A according to the second embodiment. Specifically, FIG. 29 is a flowchart of a process to execute the one-point binding illustrated in FIGS. 23A to 23C.

For example, the controller 100 executes the post-processing illustrated in FIG. 29 when the controller 100 acquires an instruction to execute the post-processing from the image forming apparatus 2. In the following description, the instruction to execute the post-processing may be referred to as a “post-processing command.” The post-processing command includes, for example, the number of sheets P of the sheet bundle Pb, the number of sheet bundles Pb to be subjected to binding processing (referred to as “required number of copies”), the binding position B1 (corresponding to the liquid application position B1), a binding angle (corresponding to a liquid application angle), and a process that is executed in parallel with the liquid application process (i.e., punching a hole in the present embodiment). In the following description, the number of sheets P of the sheet bundle Pb may be referred to as a “given number N.” At the start of the post-processing, the liquid application unit 140 is at the standby position HP corresponding to the standby position HP illustrated in FIGS. 23A to 23C whereas the rotary bracket 142 is held at the standby angle.

First, in step S801, the controller 100 drives the liquid-applier moving motor 137 to move the liquid application unit 140 in the main scanning direction such that liquid application head 146 moves from the standby position HP to a position where the liquid application head 146 can face the liquid application position B1 corresponding to the binding position B1 illustrated in FIGS. 23A to 23C. In addition, in step S801, the controller 100 drives the application-head pivot motor 150 to rotate the rotary bracket 142 such that the liquid application head 146 rotates from the standby angle to the liquid application angle. It is ascertained based on a pulse signal output from a rotary encoder of the liquid-applier moving motor 137 that the liquid application head 146 has reached the position where the liquid application head 146 can face the liquid application position B1. Similarly, it is ascertained based on a pulse signal output from a rotary encoder of the application-head pivot motor 150 that the liquid application head 146 has reached the liquid application angle.

Further, in step S801, the controller 100 drives the crimper moving motor 238 to move the crimper 32′ from the standby position HP to the position where the crimper 32′ can face the binding position B1 as illustrated in FIGS. 23A and 23B. Furthermore, in step S801, the controller 100 drives the crimper pivot motor 239 to rotate the crimper 32′ from the standby angle to the binding angle, which may be referred to as a crimp binding angle in the following description. It is ascertained based on a pulse signal output from a rotary encoder of the crimper moving motor 238 that the crimper 32′ has reached the position where the crimper 32′ can face the binding position B1. Similarly, it is ascertained based on a pulse signal output from a rotary encoder of the crimper pivot motor 239 that the crimper 32′ has reached the crimp binding angle.

Subsequently, in step S802, the controller 100 drives the conveyance roller pairs 10 and 11 to start conveying the sheet P on which an image is formed by the image forming apparatus 2. In step S803, the controller 100 determines whether the liquid application position B1 on the sheet P has faced the liquid application unit 140 (more specifically, the liquid application head 146). In other words, the controller 100 determines whether the liquid application unit 140 has faced the liquid application position B1 on the sheet P. When the liquid application position B1 on the sheet P has not faced the liquid application head 146 (NO in step S803), the controller 100 repeats the determination in step S803. In other words, the controller 100 continues driving the conveyance roller pairs 10 and 11 until the liquid application position B1 on the sheet P faces the liquid application head 146. By contrast, when the liquid application position B1 on the sheet P has faced the liquid application head 146 (YES in step S803), in step S804, the controller 100 stops the conveyance roller pairs 10 and 11. It is ascertained based on a pulse signal output from a rotary encoder of a motor that drives the conveyance roller pairs 10 and 11 that the liquid application position B1 on the sheet P has faced the liquid application head 146.

In step S805, the controller 100 causes the liquid applier 131 to apply liquid to the liquid application position B1 on the sheet P. More specifically, the controller 100 rotates the application-head moving motor 151 in the first direction to bring the liquid application head 146 into contact with the liquid application position B1 on the sheet P. The controller 100 changes the pressing force of the liquid application head 146 (in other words, the amount of rotation of the application-head moving motor 151) depending on the amount of liquid to be applied to the sheet P.

The amount of liquid that is applied to the sheet P may be the same for all the sheets P of the sheet bundle Pb or may be different for each sheet P. For example, the controller 100 may apply a decreased amount of liquid to the sheet P conveyed later. The amount of rotation of the application-head moving motor 151 may be ascertained based on a pulse signal output from a rotary encoder of the application-head moving motor 151.

In step S806, the controller 100 drives the conveyance roller pairs 10, 11, 14, and 15 to place the sheet P on the internal tray 22. In step S806, the controller 100 moves the side fences 24L and 24R to align the position of the sheet bundle Pb placed on the internal tray 22 in the main scanning direction. In short, the controller 100 performs so-called jogging.

In step S807, the controller 100 determines whether or not the number of sheets P placed on the internal tray 22 has reached the given number N of sheets indicated by the post-processing command. When the controller 100 determines that the number of sheets P placed on the internal tray 22 has not reached the given number N of sheets (NO in step S807), the controller 100 executes the operations of steps S802 to S806 again.

By contrast, when the controller 100 determines that the number of sheets P that are placed on the internal tray 22 has reached the given number N of sheets (YES in step S807), in step S808, the controller 100 causes the crimper 32′ to crimp and bind the binding position B1 (corresponding to the liquid application position B1) on the sheet bundle Pb to which the liquid has been applied by the liquid applier 131. In addition, in step S808, the controller 100 rotates the conveyance roller pair 15 to output the sheet bundle Pb thus crimped and bound to the output tray 26.

The controller 100 drives the liquid applier moving motor 137 to move the liquid applier 131 to the standby position HP and drives the crimper moving motor 238 to move the crimper 32′ to the standby position HP.

When the post-processing command includes an instruction to form a plurality of sheet bundles Pb (i.e., the requested number of copies), the controller 100 determines whether the number of sheet bundles Pb output to the output tray 26 has reached the requested number of copies as in step S1008 in FIG. 9. When the controller 100 determines that the number of the sheet bundles Pb output to the output tray 26 has not reached the requested number of copies, the controller 100 repeats the operations of steps S802 to S808. By contrast, when the controller 100 determines that the number of sheet bundles Pb output to the output tray 26 has reached the requested number of copies, the controller 100 moves the liquid applier 131 and the crimper 32′ to the standby position HP as described above.

The embodiments of the present disclosure are applied to the edge binder 25 that executes the edge stitching as described above. However, the embodiments of the present disclosure may be applied to the saddle binder 28 that executes the saddle stitching.

The control method described above may be implemented by, for example, a program. For example, the control method may be executed by causing an arithmetic device, a storage device, an input device, an output device, and a control device to operate in cooperation with each other based on a program. The program may be written in, for example, a storage device or a storage medium and distributed, or may be distributed through, for example, an electric communication line.

Embodiments of the present disclosure are not limited to the above-described embodiments, and numerous additional modifications and variations are possible in light of the teachings within the technical scope of the appended claims. It is therefore to be understood that the disclosure of this patent specification may be practiced otherwise by those skilled in the art than as specifically described herein, and such, modifications, alternatives are within the technical scope of the appended claims. such modifications and alternatives are within the technical scope of the appended claims.

Now, a description is given of some aspects of the present disclosure.

Initially, a description is given of a first aspect.

A medium processing apparatus includes: a liquid applier to apply liquid to a part of a medium, the medium being at least one medium; and

a post-processing device to perform processing on a bundle of media including the medium to which the liquid is applied by the liquid applier.

the liquid applier includes:

a first liquid storage to store the liquid to be applied by the liquid applier;

a first liquid supply portion having one end immersed in the liquid stored in the first liquid storage to absorb the liquid toward another end of the first liquid supply portion; and

a liquid application member coupled to said another end of the first liquid supply portion to contact the medium to apply the liquid supplied from the first liquid supply portion to the medium.

A contact surface of the liquid application member with the medium is at a position higher than a position of an uppermost surface of the liquid stored in the first liquid storage.

A description is given of a second aspect.

In the medium processing apparatus according to the first aspect, the first liquid supply portion is configured to absorb the liquid stored in the first liquid storage by capillary action.

A description is given of a third aspect.

In the medium processing apparatus according to the first or second aspect, the first liquid supply portion is made of the same material as the liquid applier.

A description is given of a fourth aspect.

In the medium processing apparatus according to the first or second aspect, the first liquid supply portion is integrated with the liquid application member as a unit.

A description is given of a fifth aspect.

In the medium processing apparatus according to any one of the first to fourth aspects, the liquid application member is movable between a position at which the liquid application member contacts the medium and a position at which the liquid application member is away from the medium. The first liquid storage is movable in conjunction with movement of the liquid application member.

A description is given of a sixth aspect.

In the medium processing apparatus according to any one of the first to fourth aspects, the liquid application member is movable between a position at which the liquid application member contacts the medium and a position at which the liquid application member is away from the medium. The first liquid storage is fixed to retain a constant position regardless of movement of the liquid application member.

A description is given of a seventh aspect.

The medium processing apparatus according to any one of the first to sixth aspects includes a second liquid storage that stores the liquid and a second liquid supply portion to supply the liquid stored in the second liquid storage to the first liquid storage.

A description is given of an eighth aspect.

In the medium processing apparatus according to the seventh aspect, a first supply speed of the liquid supplied from the first liquid storage to the liquid application member through the first liquid supply portion is lower than a second supply speed of the liquid supplied from the second liquid storage to the first liquid storage through the second liquid supply portion.

Now, a description is given of a ninth aspect.

The medium processing apparatus according to the eighth aspect includes a liquid supplier to supply the liquid stored in the second liquid storage to the first liquid storage through the second liquid supply portion at the second supply speed.

A description is given of a tenth aspect.

The medium processing apparatus according to the ninth aspect includes: a first liquid sensor to detect an amount of the liquid stored in the first liquid storage; and a controller to drive the liquid supplier to supply the liquid from the second liquid storage to the first liquid storage in response to the amount of the liquid detected by the first liquid sensor being below a first threshold value.

A description is given of an eleventh aspect.

The medium processing apparatus according to the tenth aspect includes a second liquid sensor to detect an amount of the liquid stored in the second liquid storage; and a notifier to notify information. In response to the amount of the liquid detected by the second liquid sensor being below a second threshold value, the controller causes the notifier to notify replenishment of the liquid to the second liquid storage.

A description is given of a twelfth aspect.

In the medium processing apparatus according to any one of the first to eleventh aspects, the liquid applier includes: a cover that houses the liquid application member, the cover having an opening at a lower end of the cover; and a cap movable to a closing position at which the cap closes the opening and a retracted position at which the cap is retreated from the opening. When the cap is at the retracted position, the liquid application member contacts the medium through the opening to apply the liquid to the medium.

A description is given of a thirteenth aspect.

The medium processing apparatus according to the twelfth aspect includes a first urging member that urges the cap toward the closing position. The cap contacts the liquid application member moving inside the cover toward the medium and moves from the closing position to the retracted position against urging force of the first urging member. The cap contacts the liquid application member moving inside the cover in a direction away from the medium and moves from the retracted position to the closing position by the urging force of the first urging member.

A description is given of a fourteenth aspect.

In the medium processing apparatus according to the twelfth or thirteenth aspect, the cover is movable in a contact direction to contact the medium and a separating direction to separate away from the medium. The liquid applier changes among a first state in which the lower end of the cover is away from the medium and the cap is at the closing position, a second state in which the lower end of the cover contacts the medium and the cap is at the closing position, and a third state in which the lower end of the cover contacts the medium, the cap is at the retracted position, and the liquid application member contacts the medium.

A description is given of a fifteenth aspect.

In the medium processing apparatus according to the fourteenth aspect, the liquid applier includes: a holder that holds the liquid application member and supports the cover such that the cover is movable in the contact direction to contact the medium and in the separating direction to separate away from the medium; a second urging member that urges the cover in a direction away from the holder; and a holder mover to move the holder in an approaching direction to approach the medium and a moving-away direction to move away from the medium. Moving the holder from the first state in the approaching direction causes the cover to move, together with the holder in the contact direction, to change the liquid applier to the second state. Further moving the holder in the approaching direction from the second state against an urging force of the second urging member causes the liquid application member to move inside the cover in a direction in which the liquid application member contacts the medium, to change the liquid applier to the third state.

A description is given of a sixteenth aspect.

In the medium processing apparatus according to the fourteenth or fifteenth aspect, the liquid applier adjusts a movement amount of the liquid application member when the liquid applier changes from the first state to the third state, in accordance with a thickness of the medium or a number of media.

A description is given of a seventeenth aspect.

The medium processing apparatus according to any one of the fourteenth to sixteenth aspects includes a first sealer that covers the lower end of the cover. The first sealer is in intimate contact with the medium when the liquid applier is in the second state or the third state.

A description is given of an eighteenth aspect.

The medium processing apparatus according to any one of the fourteenth to seventeenth aspects includes a liquid-applier movement assembly to move the liquid applier between a liquid application position facing the medium and a standby position away from the liquid application position. The liquid applier includes a reflux mechanism to contact the liquid application member when the liquid applier is at the standby position and in the third state, to reflux the liquid ejected from the liquid application member to the first liquid storage.

A description is given of a nineteenth aspect.

In the medium processing apparatus according to any one of the twelfth to eighteenth aspects, the cap is supported to be rotatable inside a cutout at a circumferential portion of the cover, and closes the cutout when the cap is located at the retracted position.

A description is given of a twentieth aspect.

In the medium processing apparatus according to any one of the twelfth to nineteenth aspects, the liquid applier includes a second sealer on an outer peripheral surface of the cap. The second sealer is in intimate contact with an inner peripheral surface of the cover when the cap is at the closing position.

A description is given of a twenty-first aspect.

An image forming system includes: an image forming apparatus to form images on a plurality of media; and the medium processing apparatus according to any one of the first to twentieth aspects to perform the processing on the plurality of media on which the images have been formed by the image forming apparatus.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

This patent application is based on and claims priority to Japanese Patent Application No. 2022-086931, filed on May 27, 2022, Japanese Patent Application No. 2022-100950, filed on Jun. 23, 2022, Japanese Patent Application No. 2023-048397, filed on Mar. 24, 2023, and Japanese Patent Application No. 2023-049890, filed on Mar. 27, 2023, in the Japan Patent Office, the entire disclosure of each of which is hereby incorporated by reference herein.

### REFERENCE SIGNS LIST

1: image forming system
2: Image forming apparatus
3: Post-processing apparatus
10 to 19: Conveyance Roller Pairs
20: Switching claw
21, 26, and 30: Output trays
22: Internal tray
23 and 27: End fences
24L and 24R: Side fences
25: Edge Binder
28: Saddle binder
29: Sheet folding blade
31: Liquid applier
32: Crimper
32a and 32b: Binding teeth
32d: Contact-separation motor
33: Lower pressure plate
34: Upper pressure plate
34a: Through hole
35: Liquid-applier movement assembly
37: Liquid-applier moving motor
38: Trapezoidal screw
39: Nut
40: Base plate
40a: Position sensor
41a and 41b: Columns
42a and 42b: Coil springs
43: First liquid-storage tank
43a and 52a: Liquid amount sensors
44: Liquid application member
45: First liquid supply portion
46: Holder
47: Edge-binder movement assembly
48: Base
49: Guide shaft
50: Edge-binder moving motor
51: Standby-position sensor
52: Second liquid-storage tank
53: Third liquid-storage tank
54: Second liquid supply portion
55: Liquid supply pump
100: Controller
101: CPU
102: RAM
103: ROM
104: HDD
105: I/F
109: Common bus
110: Control panel

1. A medium processing apparatus, comprising:
a liquid applicator configured to apply liquid to a part of a medium, the medium being at least one medium; and
a post-processing device configured to perform processing on a bundle of media including the medium to which the liquid was applied;
the liquid applicator including:
a liquid storage configured to store the liquid to be applied by the liquid applicator;
a liquid supply portion having a first end immersed in the liquid stored in the liquid storage, the first end configured to absorb the liquid toward a second end of the liquid supply portion; and
a liquid application member coupled to the second end of the liquid supply portion, the liquid application member having a contact surface, the contact surface configured to contact the medium and apply the liquid supplied from the liquid supply portion to the medium,
the contact surface of the liquid application member with the medium being at a position higher than a position of an uppermost surface of the liquid stored in the liquid storage.

2. The medium processing apparatus according to claim 1, wherein the liquid supply portion is configured to absorb the liquid stored in the liquid storage by capillary action.

3. The medium processing apparatus according to claim 1, wherein the liquid supply portion is made of the same material as the liquid applicator.

4. The medium processing apparatus according to claim 1, wherein the liquid supply portion is integrated with the liquid application member.

5. The medium processing apparatus according to claim 1, wherein
the liquid application member is configured to move between a position at which the liquid application member contacts the medium and a position at which the liquid application member is away from the medium; and
the liquid storage is configured to move in conjunction with movement of the liquid application member.

6. The medium processing apparatus according to claim 1, wherein
the liquid application member is configured to move between a position at which the liquid application member contacts the medium and a position at which the liquid application member is away from the medium; and
the liquid storage is fixed and configured to retain a constant position regardless of movement of the liquid application member.

7. The medium processing apparatus according to claim 1, further comprising:
a second liquid storage configured to store the liquid; and
a second liquid supply portion configured to supply the liquid stored in the second liquid storage to the liquid storage.

8. The medium processing apparatus according to claim 7, wherein
a first supply speed of the liquid supplied from the liquid storage to the liquid application member is lower than a second supply speed of the liquid supplied from the second liquid storage to the liquid storage through the second liquid supply portion.

9. The medium processing apparatus according to claim 8, further comprising:
a liquid supplier configured to supply the liquid stored in the second liquid storage to the liquid storage through the second liquid supply portion at the second supply speed.

10. The medium processing apparatus according to claim 9, further comprising:
a liquid sensor configured to detect an amount of the liquid stored in the liquid storage; and
processing circuitry configured to drive the liquid supplier to supply the liquid from the second liquid storage to the liquid storage in response to the amount of the liquid detected by the liquid sensor being below a threshold value.

11. The medium processing apparatus according to claim 10, further comprising:
a second liquid sensor configured to detect an amount of the liquid stored in the second liquid storage; and
a display configured to display notification information,
wherein the processing is configured to cause the display to the notification information, the notification information indicating a replenishment of the liquid to the second liquid storage in response to the amount of the liquid detected by the second liquid sensor being below a second threshold value.

12. The medium processing apparatus according to claim 1, wherein
the liquid applicator includes,
a cover configured to house the liquid application member, the cover having an opening at a lower end of the cover, and
a cap configured to move to a closing position at which the cap closes the opening, and move to a retracted position at which the cap is away from the opening; and
the liquid application member is configured to apply the liquid to the medium by contacting the medium through the opening in response to the cap being at the retracted position.

13. The medium processing apparatus according to claim 12, further comprising:
an urging member configured to urge the cap toward the closing position, wherein
the cap contacts the liquid application member moving inside the cover toward the medium, and moves from the closing position to the retracted position against an urging force of the urging member, and
the cap contacts the liquid application member moving inside the cover in a direction away from the medium, and moves from the retracted position to the closing position by the urging force of the urging member.

14. The medium processing apparatus according to claim 12, wherein
the cover is configured to move in a contact direction to contact the medium, and to move in a separating direction to separate away from the medium; and
the liquid applicator is configured to changes from among a first state in which the lower end of the cover is away from the medium and the cap is at the closing position, a second state in which the lower end of the cover contacts the medium and the cap is at the closing position, and a third state in which the lower end of the cover contacts the medium, the cap is at the retracted position, and the liquid application member contacts the medium.

15. The medium processing apparatus according to claim 14, wherein
the liquid applicator includes,
a holder configured to hold the liquid application member and support the cover such that the cover is movable in the contact direction to contact the medium and moveable in the separating direction to separate away from the medium;
a second urging member configured to urge the cover in a direction away from the holder; and
a holder mover configured to move the holder in an approaching direction to approach the medium and a moving-away direction to move away from the medium,
the moving the holder in the approaching direction while the liquid applicator is in the first state causes the cover to move together with the holder in the contact direction, and causes the liquid applicator to change to the second state, and
further moving the holder in the approaching direction against an urging force of the second urging member while the liquid application is in the second state causes the liquid application member to move inside the cover in a direction in which the liquid application member contacts the medium, and causes the liquid to change to the third state.

16. The medium processing apparatus according to claim 14, wherein the liquid is configured to:
adjust a movement amount of the liquid application member in response to the liquid applicator changing from the first state to the third state, in accordance with a thickness of the medium or a number of media.

17. The medium processing apparatus according to claim 14, further comprising:
a sealer configured to,
cover the lower end of the cover, and
be in contact with the medium in response to the liquid applicator being in the second state or the third state.

18. (canceled)

19. The medium processing apparatus according to claim 12, wherein
the cap is configured to be rotatable inside a cutout at a circumferential portion of the cover; and
the cap is configured to close the cutout in response to the cap being at the retracted position.

20. The medium processing apparatus according to claim 17, wherein
the liquid applicator includes an outer sealer on an outer peripheral surface of the cap; and
the outer sealer is in contact with an inner peripheral surface of the cover in response to the cap being at the closing position.

21. An image forming system, comprising:
an image forming apparatus configured to form images on a plurality of media; and
the medium processing apparatus according to claim 1, the medium processing apparatus configured to perform the processing on the plurality of media on which the images have been formed by the image forming apparatus.
